(19) United States
(12) Patent Application Publication
(10) Pub. No.: US 2014/0236817 A1
(43) Pub. Date: Aug. 21, 2014

(54) BAR CODED MONETARY TRANSACTION SYSTEM AND METHOD

(71) Applicant: PAYSCAN AMERICA, INC., Rolling Hills Estates, CA (US)

(72) Inventors: John F. Meyer, Orange, CA (US); Louis Krouse, Rancho Palos Verdes, CA (US)

(73) Assignee: PAYSCAN AMERICA, INC., Rolling Hills Estates, CA (US)

(21) Appl. No.: 13/943,628

(22) Filed: Jul. 16, 2013

Related U.S. Application Data
(63) Continuation of application No. 13/614,033, filed on Sep. 13, 2012, now abandoned.
Application No. 13/614,033 is a continuation of application No. 13/156,256, filed on Jun. 8, 2011, now abandoned.
Application No. 13/156,256 is a continuation of application No. 11/932,048, filed on Oct. 31, 2007, now abandoned.

(51) Int. Cl. G06Q 20/10

(52) U.S. Cl. CPC G06Q 20/102
USPC 705/40

(57) ABSTRACT

A monetary transaction system allowing a biller to generate an invoice for a customer with a bar code comprising data identifying the customer and the biller, and a scanning apparatus for use by a third party configured both to scan the bar code and, based on the identifying data, to effect payment to the biller in a predetermined or customer-specified amount.

### PRIORITY APPLICATION

This application is a continuation of U.S. application Ser. No. 13/614,033, filed Sep. 13, 2012, which is a continuation application of U.S. application Ser. No. 13/156,256, filed Jun. 8, 2011, which is a continuation of U.S. application Ser. No. 11/932,048, filed Oct. 31, 2007, the entire disclosure of all of which are hereby incorporated by reference herein and should be considered a part of this specification.

### BACKGROUND OF THE INVENTION

The present disclosure relates to a system and method for performing electronic monetary transactions.

The current paradigm of the bill payment cycle for goods and services rendered has improved only in incremental steps since the beginning of time. In ancient times, most goods and services were exchanged between individuals, using the common currency of the realm or by a mutually agreed upon barter arrangement. Extension of credit for goods and services was generally limited to the wealthy. When payment was due, handwritten invoices were hand delivered. Sometime later, cash payment would be remitted in person. Most trade occurred at the local level between individuals, exchanging cash or barter goods.

Until the late 1800's and early 1900's in the United States, credit for goods and services rendered remained essentially unchanged at the local level. Society then became less stratified and there became an affluent middle class. Credit for goods and services became extended to select groups and individuals within this populace as well as the wealthy. However, invoices were still handwritten tallies of goods and services rendered, which were paid for in cash. The late Industrial Revolution precipitated many technology advances in transportation and communication, which affected many facets of daily life. In commerce, the foundation cornerstones of the financial services industry, as it exists today, were developed and shaped. With an infrastructure of a national mail network and a solid central banking system in place, the more wealthy individuals began to have a larger and more convenient span of financial control with extended remote banking credit services. Merchants could then send their invoices to distant customers through the national mail network and receive payments, some time later, in the form of a bank draft honored by the local bank for cash.

In the generations following World War II to the present time, with general society becoming more and more homogenized, and on the whole more affluent, banking services became available and competitive at every level. Bank checking accounts (and therefore a credit mechanism with which to pay remote billers) are today available to 60 percent or more of the population. The national mail network is a very cost-effective delivery system for local and remote customers of automated or machine printed monthly invoice statements, which now average 16 billion annually. Customers write checks, as payment for these invoices, and return them via the mail network. When received at the merchant directed return location (a bill payment-processing center), these mail payments are opened, the checks deposited, and the customer accounts credited with the face amount of these check payments.

If everyone were to pay their bills on or before the due date with valid checks, this state of the bill payment industry might be sufficient to satisfy most of today's societal needs. However, this is not the case. Some people never pay their bills on time, for a variety of reasons. Payments made with a check are not always covered with sufficient funds at their bank. The end-result consequence to the biller is a finite cost that is directly attributable to the disruption of the flow of goods and services through the business.

To cover the costs incurred by these late payments, billers have only two options available. One option is to spread this overhead cost over all the goods and services that they provide, with the possible consequence of pricing their products or services out of the competitive price range for a similar or substitute set of products and services. The second option is to impose payment penalties on those customers who pay late—for whatever reason. This second option is generally preferable, since it targets the problem population segment directly. However, billers are often unable to recover the full cost of late payment consequences from those customers and still stay within public legal and regulatory mandates.

Recently, there have been business attempts to further automate the bill payment process by the electronic delivery of biller invoices and the subsequent electronic remittance of payments. While the electronic presentment of bill payments might address the current 70% or so of the U.S. population with access to the Internet, it does not address the 30% without Internet access. Despite the hopes of technology vendors, there is little evidence that expansion of the Internet-wired segment of the population will eliminate this disparity over the next decade. The latest statistics show that less than 10% of the American public may regularly use on-line remittance services.

Moreover, Federal statistics indicate that fully 30-40% of the U.S. population may be “unbanked”. The “unbanked” population operates solely within the cash economy without any formal banking level traceability. There are many reasons that people may need or prefer to avoid banks, some of which are culturally or financially related. Some prefer anonymity for quite specific reasons, such as illegal aliens avoiding detection and deportation by the INS, or others hiding their sources of income from the IRS. Federal statistics also indicate that 30-40% of the adult U.S. population may have a working fourth grade education or less.

There may be a correlation between those people opting for the cash economy and the fact that many may be unwilling or unable to maintain and balance a checkbook. Most people would rather admit to being “unbanked” rather than to being illiterate. The “unbanked” segment of the population has difficulty operating in a check-oriented society and paying their monthly bills to remote billers. At the local level, the proprietor-operated check cashing storefronts may service some of the needs of these individuals. Weekly paychecks are cashed for a transaction charge (mostly based on the face value of the check), and money orders are then bought, to be enclosed with mailed bill payments. When bill payments are long past their due date, these individuals may have to resort to more expensive electronic wire services to avoid service disconnects.

For the great majority of printed bill payment invoices that are distributed every month, each biller automates and optimizes its bill collection and remittance process to suit the requirements of its installed paper handling equipment, its customer account numbering assignments, and related schemes. Bill remittance stub sizes and formats vary from postcards printed with dot matrix printers to full-page 8½″ by 11″ sheets with laser printed invoice information on pre-printed forms. Each usually has a tear-off bill remittance stub portion that is then mailed back with a check payment. Account numbers on these bill remittance stubs appear in different (and sometime multiple) spatial positions, formats, and fonts. While still not universal, most billers have formatted their account numbers (and other customer related information) on bill remittance stubs in Optical Character Recognition (OCR) readable scan lines, using special fonts such as OCR-A and OCR-B. Some of this information is printed twice on the bill remittance stub as a contingency against the paper bill remittance stub being shredded or mangled by the automation equipment. Human data entry of this customer account number information is the ultimate fallback mode for processing such a payment.

FIG. 1 shows an exemplary local gas company remittance stub 100 utilizing this manner of design. The biller in this example has assigned a numeric account number to each customer. As shown in FIG. 1, the customer account number is printed three times, the human readable one 102 under the “Your Account Number” heading, and the other two 103, 104 printed twice in OCR-optimized form. Account number check digits 101 are used to validate the account number. Each digit in the account number is multiplied by a mathematical weight, and then all these products are added together. Dividing the total sum by 10 leaves a remainder (modulus) which is complemented (in base 10) to yield a check digit value; this is compared against the indicated digit on the stub. If these digits match, then the account number has been detected and read correctly. Check digits are employed to eliminate two types of common errors: physical digit read errors and transposition errors (when the customer account number is processed manually).

FIG. 2 shows an exemplary remittance stub 200 from a local power company that assigns a combination of letters and digits to its customers. There are two forms of the customer account number 201 that appear on the bill remittance stub. The first 201 is designed to be human readable and appears within a printed text box labeled “Account Number”. The last digit in the Account Number box is the customer account number check digit. The second form of the customer account number 202 appears in machine-readable form and is embedded in the OCR scan line (underlined for illustration). The leading “4” digit is the customer account number check digit; the remainder of the underlined portion of the OCR line are the digits that can be mapped into the human readable “Account Number” form. The format of this machine-readable OCR scan line 202 is probably a confluence of many internal design decisions, based on several factors. From a human ergonomics perspective, a customer service representative of the power company, during a service call, would never ask a customer to recite an account number from a sequence of digits appearing within the machine-readable OCR line and expect a correct answer. The human readable form 201 of the customer account number is far easier for a customer to recognize and to dictate over the telephone when requesting service changes to an account.

These two examples illustrate the primary uses of duplicate account information printed on a bill remittance stub—one for simplicity when verbally referring to a specific customer account, and the second for the case that the automation process fails and customer account number payment information has to be entered manually. A recent trend among some billers, however, is to eliminate the human-readable account number from the stub, to help deter identity theft. (This is despite the fact that the OCR information is still visible; but this change may presage the replacement of OCR with bar code data. Although a determined criminal would not be thwarted by such means, it could create a barrier for casual or underage incidents.)

FIG. 3 shows an exemplary remittance stub 300 from a gas company, in which the biller automates part of the bill payment remittance process by including, on the bill remittance stub, company proprietary bar coded information 301 that does not appear to be related in any way to the printed customer account number. The biller intends this enhancement to expedite processing. However, although the format of this bill remittance stub 300 may marginally advance that biller's state-of-the-art bill collection and system processing, through the use of newer and improved automation equipment, it does not significantly decrease the overall bill payment cycle in favor of the customer. The great majority of the bill payment cycle time consists of non-deterministic delays in the national mail network during the biller-to-customer and the payment-to-biller delivery paths. These random delays, combined with very short biller dictated due dates and (possibly intentional) delayed processing times, always work to the detriment of the customer. As a result, some customers are assessed penalty payments, which are sometimes more profitable to the biller than the basic goods and services provided.

The system of bill payment invoicing, collection and remittance processing remains a fragmented industry because there are no common bill remittance stub format standards, no common customer account number representation standards, no common, expedient data and money delivery mechanisms to the biller, and no large bill remittance stub processing networks. These barriers are in addition to the intrinsic payment cycle delays that always work to the detriment of the customer to favor the biller (with a correspondingly greater profit margin). By constructing a common set of standards from the current set of available technology components, a universal national bill payment network could be implemented that addresses the above list of industry problems, resulting in a positive economic impact to the business community at large, while delivering more fair and consistent service to the consumer. For such a set of standards to work, the cooperation of several large organizations would be required; however increases in raw profit and new business growth opportunities should induce such cooperation.

As shown in FIG. 4, a system 400 consistent with the existing bill payment paradigm uses the national mail network and biller payment processing centers to convert physical paper into electronic data and bank credits. The current bill payment network is a paper based network that primarily relies on the central banking system for processing customer remitted bank draft payments, and on the national mail network for customer invoice delivery and the return of mailed bill payments. In system 400, for all the goods and services rendered to a customer over a given billing period, the biller accounts receivable 401 accumulates a dollar total, and generates a detailed machine printed invoice (which may take 4-5 days after account cut-off time to process) that is sent to the customer 403 via U.S. Mail 402. The customer (i.e. the bill payer) 403 typically receives the invoice 2-3 days later (which time is variable, without any direct traceability from the perspective of either the biller or the customer).

Once the customer receives the invoice in the mail, the customer makes out a check payment or procures a money order 404 to remit with a mail payment, which occurs sometime later, depending on the availability of cash resources and other circumstances. The customer mails the payment via U.S. Mail 405 to the biller collection and processing center 406, where processing time may be 2-3 business days or more (which time, again, is variable, without any direct traceability from the perspective of either the biller or the customer). At the bill payment processing center 406, the following operations are typically performed: opening all received mail; microfilming and/or otherwise recording all received payments; electronically reading and processing OCR bill remittance stub information; preparing all received check or money order payments for bank submission; and electronically remitting bill payment data, based on check payment verification. Processing time within the processing center 406 may be 2-3 days. The customer has no direct traceability over this process, other than knowing the date of mailing, and (if purchased from the postal carrier) a confirmation of receipt.

It should be noted that, when sanctioned late payment penalties are imposed on credit payments, a biller might take advantage of the untraceability of remittance times by intentionally delaying an on-time payment by a day or so, thereby causing an otherwise on-time payment to be considered late. For example, for a $200 payment delayed by only one day, a $25 late payment penalty might result in an equivalent Annual Percentage Rate (APR) interest rate of 150%, for little or no marginal cost to the biller (ignoring its ethical and legal ramifications). This overcharge, which may be difficult for the customer to trace later, may be compounded by another finance charge for the outstanding unpaid balance amount, made late by that intentional delay. Although some billers offer a “grace period” or will occasionally forgive such fees, many do not, particularly with habitual later payers.

Payment data is next remitted electronically from the processing center 406 to the biller's bank 408, where processing and distribution of electronic payment data is typically done using the Federal Reserve Automated Clearing House (ACH) Network 407, which typically takes 6-9 hours. At the biller's bank 408, the electronic payment data is received from the ACH Network, stripped and reformatted according to biller specified formats, which may take 4-6 hours. Finally, the biller's accounts receivable 401 and/or customer service computer files are updated. Depending on the “legacy factor” of the biller's computer processing systems, this process can range anywhere from 2-3 hours to 4-5 days.

Using the above time estimates, and assuming zero latency on the part of the customer paying a bill, the cycle time between the customer account cut-off time and the time that the payment is applied to the customer's account may range from 13-18 days. Since there is usually some customer delay, the observed bill payment cycle time will be longer.

### SUMMARY OF THE INVENTION

It is therefore an object of the present disclosure to provide a system and method for electronic monetary transactions wherein a national electronic network may be established with a plurality of retail outlets configured for processing such transactions.

It is another object of the present disclosure to provide a system and method for bill payment wherein billers benefit by receiving accurate electronic payments and related information delivered in a timely manner, which may be directly applied to their accounts receivable and other systems.

It is a further object of the present disclosure to provide a system and method for bill payment wherein bill paying customers benefit by having an electronically time stamped traceable payment that is electronically delivered and expediently applied to their account following payment, and wherein no personal computer or other customer equipment is required, and for which a tangible receipt may be obtained.

It is still another object of the present disclosure to provide a system and method for bill payment wherein participating retail establishments may obtain a relatively cost-free profit margin from each bill payment transaction processed.

It is still a further object of the present disclosure to provide a system and method for bill payment wherein a uniform bar code “signature” system is used to identify bill paying customers, billers, and other transactional information from a single bar code or equivalent, either printed on a customer remittance or displayed on an analogous transmittal medium, and which can be used to make a single payment, or reused to make subsequent payments.

The present disclosure involves the transmission of payment information via one or more networks (e.g. the Internet and the Federal Reserve ACH Network) to billers of consumer goods and services. This payment information is captured using existing scanners in cash register systems at supermarkets, chain stores, or other retail outlets, or via analogous point of sale equipment. Retailers gain access to a valuable affinity draw because everyone has bills to pay regularly. Billers save millions of dollars in collection and processing expenses. Consumers are provided a convenient way to pay any bill quickly and reliably for a nominal transaction fee (e.g. $1.50 per bill).

A bill payment system and method consistent with the present disclosure relies on an additional ISO standard printed bar code, appearing either on the biller invoice, which is then delivered to the customer via the national mail network, or on an analogous remittance medium such as a transmittal slip or cellphone screen. Thereafter, payment information and payment credits are processed at the retail site and returned to the biller electronically. With the proliferation of the Universal Product Codes (UPC) that are imprinted on every retail product today, a robust infrastructure for processing bar coded information is already in place. At supermarkets, bar code scanners at all the checkout aisles are used to register the sale of all items for inventory and pricing purposes. In this environment, bar coded bill payments would be just another commodity item to be paid for, accepted at retail. In possession of a bar coded payment invoice or similar media, the customer could pay the bill at any supermarket, chain store, post office, or other location that accepts this type of payment. In return for the nominal transaction fee, a customer might receive a printed detailed proof of payment receipt. Billers could be notified immediately and agree to suspend all collection activities, and account posting could take place within (say) 36 hours, all funds remaining within the Federal Reserve Banking system. No state banking licensing would be required, since all funds remain within existing approved conduits, and each biller's approval is secured by means of a biller registration process, which introduces the technical specifications and certification parameters necessary for billers to participate in a system consistent with the present disclosure.

When a bill payment system and method consistent with the present disclosure is adopted by a participating retail establishment, it creates a new service portal for providing services to the public. For example, a proprietary router/application interface may be non-invasively attached, indirectly, to the retailer's checkout scanner. Through this portal, other services can be offered to consumers. For example, in addition to payments, money transfers (a potentially lucrative financial service) may be provided through a system consistent with the disclosure. This system can likewise consummate transactions involving gift cards and other forms of electronic monetary transactions. Even bank account transactions such as deposits may be made or Internet wallets replenished. Though not required, the U.S. Postal Service (USPS) could be offered a new income stream for simply authorizing this system and providing an “electronic postmark”, which may impact the way billers and consumers view this system.

A system consistent with the present disclosure benefits retailers, billers, and consumers who participate. Retailers receive a desired “affinity pull” upon the consumer market space. Billers can potentially reduce what today are very expensive embedded collection costs. Consumers get a more efficient alternative to payment via the U.S. Post Office, especially those without bank accounts, those who desire to use credit for bill payments, and those who are making late payments. Establishing and maintaining such a system should be relatively easy and inexpensive, particularly since both retailers and billers have an incentive to promote its availability.

The following two example embodiments (Examples A and B) of bill payment systems and methods are consistent with the disclosure. (These and certain subsequent examples have been identified by letter, purely for convenience of reference. No inference should be drawn by the use or omission of such labels.) The first example system (Example System A) comprises: a) a mechanism allowing a biller to generate at least one invoice for at least one customer, where the invoice contains a unique bar code, comprising data identifying at least the customer and the biller; and b) a scanning apparatus and associated components, for use by a third party, configured both to scan the bar code and, based on the identifying data of the bar code, to effect payment to the biller in a predetermined or customer-specified amount. In method form, this first example (Example Method A) comprises: a) generating a biller invoice for at least one customer, said invoice containing a unique bar code, said bar code comprising data identifying at least said customer and said biller; and b) enabling a third party to scan and process said bar code and, based on the identifying data of said bar code, to effect payment to said biller in a predetermined or customer-specified amount. The second example (Example System B) is a network configuration of the same system and method. The system comprises: a) mechanisms allowing a plurality of billers to generate bar coded invoices; b) networked mechanisms allowing a plurality of third parties, in communication with said billers, to scan and effect payment for said invoices; and c) other system elements as described in the first example. In method form, the second example (Example Method B) comprises: a) generating bar coded invoices for a plurality of billers; b) enabling a plurality of third parties in communication with said billers to scan and effect payment for said invoices; and c) other method elements as described in the first example.

### Further Aspects of the Present Disclosure

A system and method for payment is further provided, wherein the system and method described above are enhanced, by enabling the biller's invoice barcode to be presented to the retailer through an “invoice surrogate,” i.e. an alternative representation of a biller's invoice, suitable for payment processing using systems and methods consistent with this disclosure. An invoice surrogate is thus an alternative form of invoice, either received, accessed, or created by the customer, and capable of presentation to the retailer in a form suitable for scanning at the retailer's point of payment. An example of an invoice surrogate is a faxed image containing the same unique bar code format that would otherwise appear on a biller invoice, i.e. a bar code comprising data identifying at least the customer and the biller. Before its presentation in bar code format, the invoice surrogate may pass through one or more intermediate forms, e.g. electronic transmission, email attachment, visual image on a cellphone screen, encoding on an ID card or RFID device, or printing on a transmittal slip.

The following two example embodiments (Examples C/D) describe two such systems and methods utilizing invoice surrogates. Both systems (Example Systems C/D) are consistent with the disclosure, and comprise: a) mechanisms allowing a plurality of billers to send invoices to at least one customer; b) mechanisms allowing a customer or a designated third party to access, create, or use an invoice surrogate for use in payment; and c) mechanisms allowing a plurality of third parties who are in communication with the billers to use an invoice surrogate's bar code data to effect payment for said customer to said biller in a predetermined or customer-specified amount. In method form (Example Methods C/D), both examples comprise: a) generating bar coded invoices for a plurality of billers; b) accessing, creating, or using an invoice surrogate to effect a presentation of invoice data for payment; and c) enabling a plurality of third parties in communication with said billers to scan or otherwise process the invoice surrogate's bar code data, and, based on the identifying data of said bar code, to effect payment to said biller in a predetermined or customer-specified amount.

In the first example embodiment of a system using an invoice surrogate (Example System C), the system described above (Example System C/D) is used by the biller to present invoices to customers via electronic or other means, rather than via traditional paper invoices. Such media are then used by the customer as invoice surrogates at the point of payment. In method form (Example Method C), the method described above (Example Method C/D) is followed, but with the customer presenting an invoice surrogate to the retailer at the point of payment.

The second example embodiment of a system using an invoice surrogate (Example System D), the system described above (Example System C/D) is used to deal with billers who do not include suitable bar codes in their invoices. The customer utilizes a “mediating technology” to create an invoice surrogate, for use at the point of payment. A mediating technology is some hardware, software, system, or other elements capable of performing necessary bridging or other operations, and might include such features as automated translation between barcode symbologies, translation of text from a paper or electronic invoice, or database lookup to convert a transaction serial number to an account number. Such mediating technologies would serve to transform data from the biller's original invoice into a bar code or equivalent representation suitable for payment. In method form (Example Method D), the method described above (Example Method C/D) is followed, but with the customer creating an invoice surrogate using mediating technology, and presenting that invoice surrogate to the retailer at the point of payment.

In both example embodiments (Examples C and D), consumers pay their bills at supermarkets, large retail chains, or other stores, and receive immediate credit from billers for their payments, which are made using a bar code presented on an invoice surrogate. The bar code is either transmitted electronically to the consumer, e.g., by fax, email, or Internet, or produced via a mediating technology. The biller receives good payment funds, deposited directly into the biller's bank account, as well as error-free electronic payment data for consumer bill payments by the next business day. (The biller will have a contractual obligation to backdate the received bill payments to the time and date the consumer actually paid, regardless of the time that the payment data took to post to the biller's accounts receivable system.)

The following further example embodiments and aspects describe alternative systems and methods that are consistent with the disclosure. Except as indicated, all these embodiments a) enable a first party to supply a printed bar code (or a surrogate form) to a second party, containing sufficient information to identify the first party, e.g. a network or biller ID and an account number; b) enable the second party to utilize this bar code to tender payment at a third party location; c) enable the third party to process the payment, collect an appropriate fee, and send funds to the first party; and d) enable the first party to access the transferred funds quickly.

In one aspect (Example Method E), a method for person-to-person money transfers comprises: a) providing a bar coded deposit slip, card, or other medium to a first party, to enable remitting of funds directly into a second party's bank account. Such funds would be quickly accessible (e.g. for withdrawal at an automated teller machine, or for a debit card purchase).

In another aspect (Example Method F), a method of transferring money between any two entities comprises: a) scanning a printed bar code, comprising data identifying at least an account number corresponding to an account to which a deposit can be made, and a destination payment network corresponding to the account; and b) transmitting funds or initiating a funds transfer to the account, based on information stored in the bar code and a payment made by a payor, in a predetermined or customer-determined amount.

In another aspect (Example Method G), a method of depositing funds to an account via a deposit slip comprises: a) providing deposit slips imprinted with a unique bar code comprising data identifying at least the account number and a destination payment network corresponding to the account number, with an optional printed account number.

In another aspect (Example Method H), a method of identifying an account via a printed or displayed bar code comprises: a) printing or displaying a bar code identifying at least an account number and a destination payment network corresponding to the account number.

In another aspect (Example Method I), a method for performing an Internet financial transaction comprises: a) transmitting or transferring to a payor a unique bar code comprising data identifying at least a payee and a destination payment network corresponding to the payee, suitable for payment as described herein.

In another aspect (Example Method J), a method of enabling a payee to receive payment from a payee comprises: a) making available to one or more payees standard bar coded or equivalent format(s) for representing, on a printed document or surrogate, data including at least a payee and a destination payment network corresponding to said payee; b) enabling one or more third parties to utilize scanning or equivalent apparatus to read data in said standard format(s) for the purpose of effecting payment; c) receiving or enabling the electronic transmission of data comprising said destination payment network identification, payee identification, and payment amount; and providing information to said destination payment network to effect transmission of funds to an account of said payee in an amount identified by said payment amount; and d) concurrently effectuating or initiating transmission of payment information to said payee.

### BRIEF DESCRIPTION OF THE DRAWINGS

FIG. 1 is an exemplary prior art remittance stub from a utility company;

FIG. 2 is another exemplary prior art remittance stub from a utility company;

FIG. 3 is another exemplary prior art remittance stub from a utility company;

FIG. 4 is a process flow diagram of an exemplary prior art bill payment system;

FIG. 5 is a process flow diagram of an exemplary bill payment system consistent with the present disclosure;

FIG. 6 is an illustration of an exemplary data structure of elements underlying the bar code “signature” in one embodiment of the present disclosure;

FIG. 7 is an illustration of another exemplary data structure of elements underlying the bar code “signature” in one embodiment of the present disclosure;

FIG. 8A is an illustration of an exemplary bar code bill payment “signature” in one embodiment of the present disclosure;

FIG. 8B is an illustration of an exemplary bar code bill payment “signature” in another embodiment of the present disclosure;

FIG. 8C is an illustration of an exemplary bar code bill payment “signature” in according to another embodiment of the present disclosure;

FIG. 9 is a table illustrating the results of an exemplary split modulus matching calculation in one embodiment of the present disclosure;

FIGS. 10 and 11 are illustrations of an exemplary Level 3 envelope in one embodiment of the present disclosure;

FIGS. 12 and 13 are process flow interaction diagrams of the mainline transaction information interchange between the checkout scanner, retailer host processor, and data collection network interface (DCNI) in processing a bar coded customer bill remittance stub, in one embodiment of the disclosure;

FIG. 14 is a system view diagram of a transaction collection system in one embodiment of the present disclosure;

FIG. 15 is an exemplary transaction processor executive controller (TPEC) display screen, in one embodiment of the disclosure;

FIG. 16 is an exemplary system monitor station (SMS) display screen, in one embodiment of the disclosure;

FIG. 17 is an exemplary end of batch monitor (EBM) display screen, in one embodiment of the disclosure;

FIG. 18 is an exemplary electronic transmission interface (ETI) display screen, in one embodiment of the disclosure;

FIG. 19 is an exemplary ETI transaction detail display screen, in one embodiment of the disclosure;

FIG. 20 is an exemplary ETI map biller-to-partner display screen, in one embodiment of the disclosure; and

FIG. 21 is an exemplary transaction browser display, in one embodiment of the disclosure.

FIG. 22 is a process flow diagram of another exemplary bill payment system consistent with the present disclosure;

FIG. 23 is an illustration of an exemplary Level 3 envelope in one embodiment of the present disclosure;

FIG. 24 is an exemplary bar coded deposit slip in one embodiment of the present disclosure;

FIG. 25 is an illustration of an exemplary gas station/convenience store debit card known in the art; and

FIG. 26 is an illustration of an exemplary gas station/convenience store debit card in one embodiment of the present disclosure.

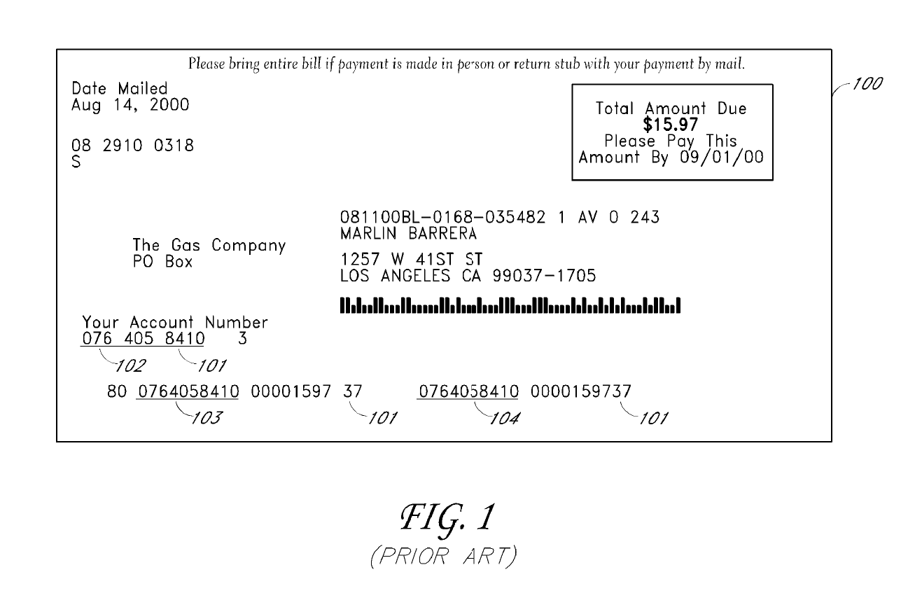

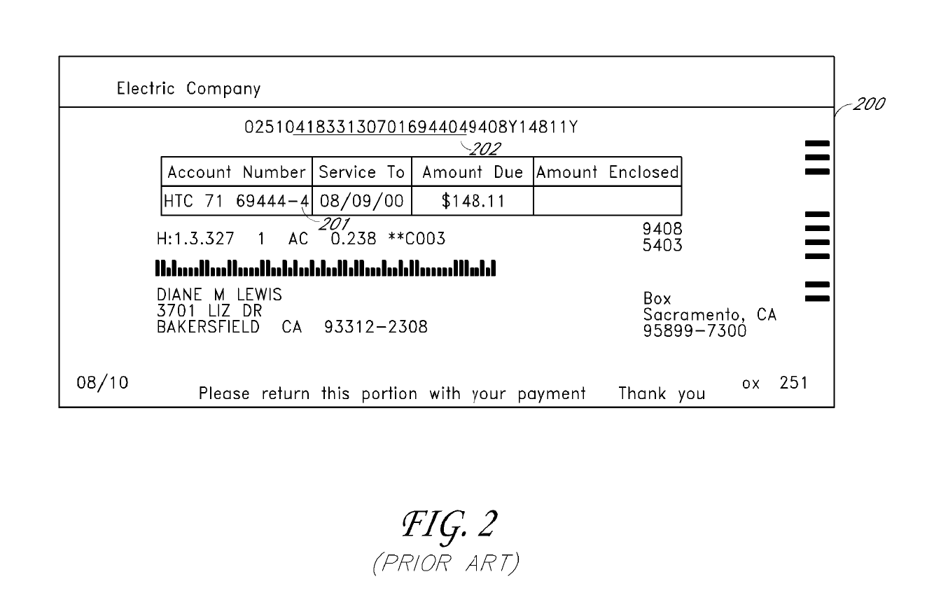

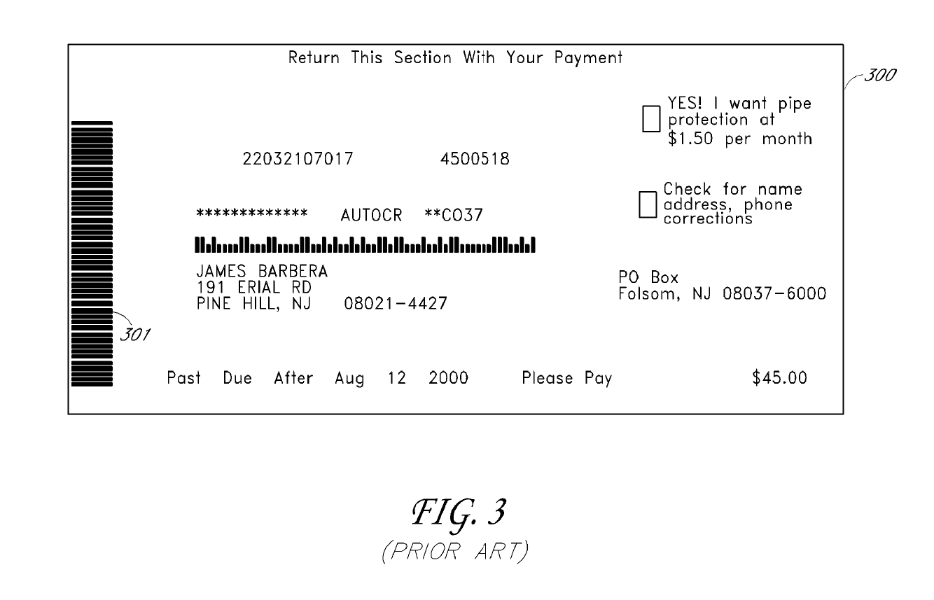

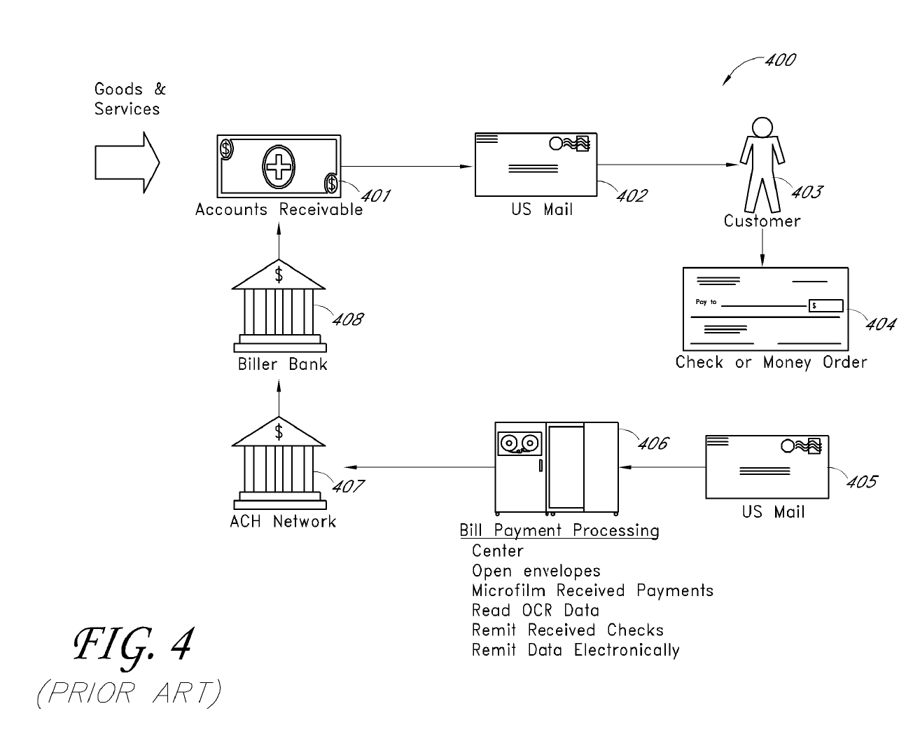

### DETAILED DESCRIPTION OF THE PREFERRED EMBODIMENT

### Bill Payment System

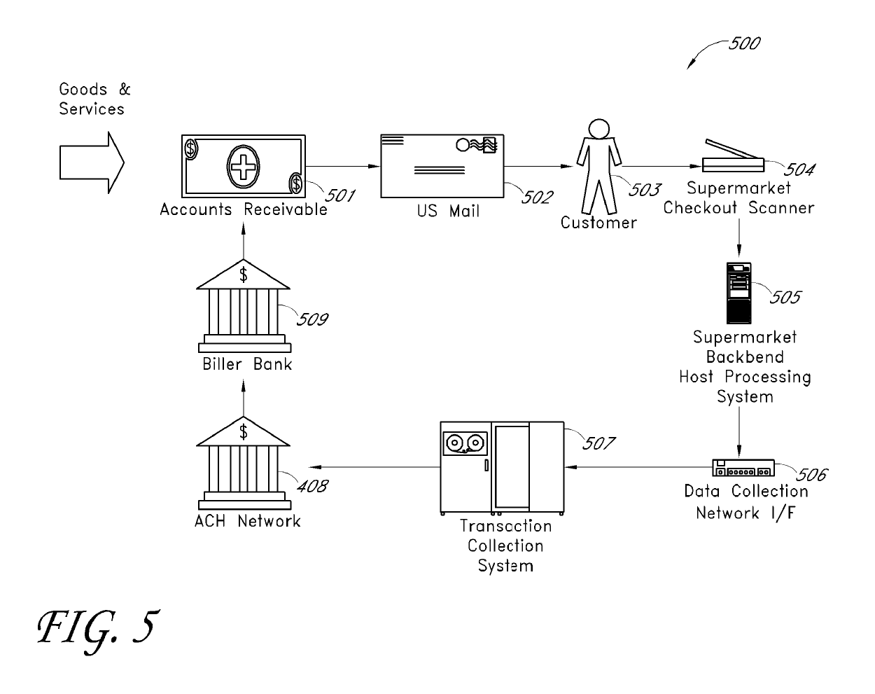

Turning now to FIG. 5, a bar coded bill payment based system 500 consistent with the present disclosure utilizes: a) a bar code on the biller invoice, which is then delivered to the customer via mail; and b) payment information and payment credits that are returned to the biller electronically. Advantageously, nationally recognized and federally sanctioned payment electronic networks may be utilized for remitting customer payment data and funds. For all the goods and services rendered to a customer over a given billing period, the biller's accounts receivable 501 accumulates a dollar total, and generates a detailed machine printed invoice including a special bar code, which is mailed to the customer 503 via U.S. Mail 502. Time for processing and mailing may be 4-5 days after account cut-off time, and the mail transit time to the customer may add an additional 2-3 business days or more before the customer receives the invoice (which time is variable, without any direct traceability from the perspective of either the biller or the customer). The customer 503 then receives the invoice in the mail. Sometime later when cash resources are available, or depending on other factors, the customer 503 decides to pay the bill. The time for this to occur is variable, depending upon the customer's circumstances.

To pay the bill, the customer 503 takes the bar-coded invoice to a participating store (e.g. a supermarket) that processes bill payments. The customer presents the bar-coded bill remittance stub to the checkout cashier for scanning at the checkout scanner 504, which may be done while paying for other UPC-coded items. Instead of looking up an in-house UPC code for pricing, the scanner 504 picks up the bill payment bar code that identifies the biller to be paid and the account number to be credited. The customer informs the checkout cashier the amount to be paid on that account, payment is tendered to the cashier, and the cashier inputs the amount to be paid into a terminal that is in communication with a backend host processing system 505. Upon receiving payment from the customer, that bill payment is then complete. The check out of any remaining products and items (or bills) continues until the complete total for all goods and services is calculated. The customer may receive a printed receipt of the payment tendered, with date and time that the payment was made. The backend host processing system 505 forwards all the payment data to the data collection network interface 506 (“DCNI”). The processing time for all of the payment steps may be as little as a few seconds. Moreover, payments made in this manner are time-stamped, so that once payment is made, the customer may rest assured that payment has been timely acknowledged.

The data collection network interface 506 collects and stores all the customer payment data in non-volatile memory. Periodically throughout the day (based on time and transaction volume thresholds), or at other predetermined intervals, the interface 506 transmits the payment data to the central site transaction collection system 507. Additional transmissions may be scheduled before the daily transaction collection system 507 aggregation times. The time for the back-end and collection system processing has no impact on customer payment time, since all payments may be time-stamped. Separately calculated calendar day payment counts and totals may also be sent to the transaction collection system 507 as an independent transaction audit balancing mechanism. The transaction collection system 507 may continuously receive payment data information from a distributed network comprising a plurality of data collection network interfaces 506 deployed at field retail establishments. Before the last processing window closes at the Federal Reserve Automated Clearing House (ACH) Network 508, all customer payments are sorted and aggregated for direct remission to their respective billers, which may take approximately an hour. Processing and distribution of electronic payment data is done using the Federal Reserve Automated Clearing House (ACH) Network 508, which (as of 2007) typically takes on the order of two hours, but may take 6-9 hours. At the biller's bank 509, the electronic payment data is received from the ACH Network, stripped and reformatted according to biller specified formats, which may take 4-6 hours. Finally, the biller's accounts receivable 501 and/or customer service computer files are updated. Depending on the “legacy factor” of the biller's computer processing systems, this process can range anywhere from 2-3 hours to 4-5 days.

Note that the system components and the sequence of events described in this embodiment are implementation-specific choices. Another embodiment might: a) implement the backend host processing system and payment terminal functions within the retailer point of sale (POS) system; b) place the data collection network interface (DCNI) functions and central site transaction collection system on a server within a payment network, such as one of the existing third-party payment processors; c) integrate payments with the normal point of sale flow (i.e. eliminating the requirement that the customer tender payment for each bill individually, distinct from other purchases, and instead incorporating such payments as items within a normal retail purchase; this change would require deferral of payment transaction submittal until payment is actually tendered, plus other transaction flow modifications).

Using the above time estimates, and assuming zero latency on the part of the customer paying his bill, and also only considering the time of biller receipt, rather than the time of customer payment, the cycle time between the customer account cut-off time and the time that the biller applies a customer payment may range from 9-12 days (in contrast to the 13-18 days of the prior art system). Since there is usually some customer delay before payment, the observed bill payment cycle time will be longer.

Moreover, the biller should recognize the customer payment date and time as the creditor date of receipt, rather than the biller's actual receipt of funds. This obligation is specified in the Federal Reserve Regulation Z, Section 226.10. In that case, the total bill payment cycle time would be reduced to 6-8 days. Explicit agreement from the biller to follow this practice would be secured through the biller registration process. The biller may validate the customer payment date with the transaction embedded “electronic postmark”, a function that cannot be performed within the current frameworks of either paper based bill payment or today's electronic payment paradigms.

In addition to the more than 55% time reduction in the bill payment cycle, other advantages of the present disclosure include: customer choice of local bill payment locations, electronic application of bill payments to accounts within 18-36 hours or less, a reduction in bill payment errors due to machine-readable bar coded account numbers, and time stamping of bill payments at the time payment is tendered. Electronically delivered bill payments, under the present disclosure, are also much cheaper for the customer to pay for, and less expensive for the biller to process through its remittance processing center and accounts receivable systems than under a prior art system. Additionally, banks that process data from the ACH system will have more chargeable services to offer their biller customers. Furthermore, billers can incorporate this bar coding standard into their bill remittance processing centers, as older OCR recognition equipment is replaced with simpler and more reliable laser bar code scanning equipment. With sufficient planning, a biller, contemplating a conversion of one or more legacy customer account numbering systems to a simpler, newer scheme, can use this system of bar coding in its conversion process. In an alternative embodiment, electronic invoice delivery, whereby the customer receives and prints the bar-coded invoice at a personal computer system, may be used to reduce the time and labor required for the biller to prepare and mail invoices to the customer.

It is further contemplated that billers would register with a centralized organization in order to receive an assigned biller bar code, just as all companies must register with the Uniform Code Council (UCC) to get their Universal Product Code (UPC) assignment for their products.

As stated above, it should be understood that the foregoing described embodiment, which uses the in-store scanner and retail host back-end machine as a means of detecting, reading and processing the bill payment bar codes is but one embodiment, and these components are not described herein as limitations. For example, another example (Example System K) might utilize a personal computer, terminal, or other equipment having a bar code capable scanner, receipt printer and an interface to a data collection network interface or biller payment network in place of the in-store system described above. Ideally, such a computer would have the same functionally equivalent interface as the in-store system. In fact, it is contemplated that, as a transitional measure, until a given retrailer modifies or updates its in-house check-out software systems as described, a simple PC might operate in its place and serve as a model prototype to demonstrate the operational aspects of this system.

### Bar Coding Validation

Prior art systems have concentrated on the visual aspects of bill remittance, including stub recognition/detection, and validation against potential fraud. Such systems have typically used optical character recognition (OCR), either with special OCR-optimized fonts/inks or with plain text. The present disclosure applies a bar code solution to the general bill payments problem, rather than a new variant or improved OCR technique. Bar code is more efficient than OCR by several magnitudes, because bar codes are a proven technology that can be detected reliably and processed by relatively simple hardware and firmware. OCR requires long physical scan times and significant host CPU processing requirements for character recognition (and then only for a selected set of fonts). Bar code consists of binary elements that are parity checked for every bar code symbol, and globally verified using check digits at the message level. OCR consists of many analog segments that have to be neurally correlated and matched to the human readable character set, with no internal self-checking controls. In short, bar code is a proven, robust, digital solution, whereas OCR in its current state is a dated analog solution that still plagues most bill payment processes today.

The Universal Product Code (UPC), printed on most retail products today, is a 12-digit number that is a concatenation of four numeric fields—a classification number (1 digit), a producer identification number (5 digits), a product identification number (5 digits), and a check digit (1 digit). The need for a standards authority first arose in 1972 when the supermarket industry decided to mark each grocery point-of-sale package with a unique identifier to speed checkout transactions, and created an organization that today is called the Uniform Code Council (UCC). The underlying bar code symbology (there are many) is merely a convenient representation of this UPC code format. Several symbologies can be reliably detected by simple point-of-sale scanning equipment; thus, it does not matter which particular bar code symbology is used.

There is no standard way of representing multiple data fields in a single scan line, given the designs and formats of various bar code standards and conventions commonly in use today. For a typical bill payment application, two fields are minimally required—a 6-7 digit biller identification and a variable length (up to 22 characters or more) alphanumeric customer account number. However, if these fields were simply concatenated in a fixed format in a single bar code scan line on a bill head, it is very doubtful that such a code could be used reliably for bill payments on the scale envisioned here. This is because multiple bar codes might appear on a given bill head, leading to ambiguity. To perform error-free data validation on this scan line, more information must be embedded within the data itself.

In the retail environment where bar coded products abound, there is a distinct need to determine that a particular bar code, when submitted for processing, is correct and valid for the target bill payment processing application. If a bill remittance stub contains more than one printed bar code sequence, one cannot assume that the retailer will always scan the correct one. If, for example, a utility company prints the new bill payment bar code, in addition to an already existing internal routing bar code, the two bar codes must be disambiguated. The utility company can easily distinguish its own internal routing code by its printed position on the bill remittance stub; however, a retail cashier might not know which one to present. The only solution is for the cashier to use trial and error. If the first bar code attempted does not validate, the second (or third, etc.) should be scanned. Validating a bar code bill payment “signature” in the course of the bill payment process is a key component of all embodiments of the present disclosure.

By using a unique bar code “signature” having multiple levels of data validation, implemented by check digit algorithms and other methods, a bar code scanning system may reliably recognize and validate a valid bill payment bar code from among a group of other bar codes. To illustrate this process, the following analogy uses the concept of paper envelopes to describe the validation method of the disclosure. Four “envelopes” are used (although those skilled in the art will recognize that any number of “envelopes” or levels of validation may be used, as shown in later examples). To avoid confusion, this analogy is presented in detail.

In this analogy, the payment data (biller code and account number) are placed on a card inside an envelope, written as a series of digits. (This may be thought of as the “payload” of the bar code “signature.”) Written instructions are then placed on the outside of that envelope, explaining how to interpret these digits (i.e. how to determine the number and length of the associated data fields). That envelope is, in turn, placed inside another envelope, on which two things are written: a check digit, based on the contents of the innermost envelope; and instructions for how to recalculate the check digit. Various different check digit algorithms might be chosen for a given situation. That envelope is, in turn, placed inside yet another envelope. It simply has a special symbol written on it, to indicate that this is a bill payment. Finally, the whole package is placed inside an outermost envelope, on which is written another check digit, based on all the contents so far. Unlike the earlier check digit, which might use one of many calculation methods, this outermost check digit is always computed the same way.

A bar code “signature” is processed in an analogous way. The following example embodiment (Example Method L) also uses four levels, corresponding to the envelopes just described. To decode such a signature, we work “from the outside in.” First, the bar code scanner reads the entire bar code text, and automatically calculates a check digit symbol which is verified against the scanned text, using rules that are part of bar code symbology standards. This is a hardware function. (This first signature level corresponds to the outermost envelope.) If this test is successful, i.e. if the scanner has correctly read all the characters, then the text is examined for a symbol indicating that the bar code is a bill payment. (This corresponds to the second envelope, which was marked with a bill payment symbol.) If this test is successful, then the remaining text is evaluated. (This corresponds to opening the second envelope.) The next bar code signature level includes a rule describing how to calculate a check digit for the remaining text. Note that this is a different check digit calculation from the one used by the bar code hardware, and is sensitive to a given payment's internal transaction format. That check digit calculation is performed, and the result is tested against the last digit in the text. If these check digits match, then the enclosed text is in turn evaluated. (This corresponds to opening the third envelope, which described a check digit calculation.) The remaining text begins with instructions on how to break the data into separate fields. (This corresponds to opening the innermost envelope, which described the sequence of its internal digits). At this point, the internal account data fields have been verified, broken apart, and are available for assembling a payment transaction.

With this example, if all four levels of validation successfully pass muster, then a valid bill payment “signature” has been detected, and the resulting data should then be passed to the target bill payment application for subsequent processing. Failure at any intermediate validation level results in a negative acknowledgement.

This bar code “signature” design unconditionally identifies the detected scanned bar code as being proprietary to the present invention, in the absence of any other external information. It does this through multiple layers of check digit information, format designator indicators, and local data validation schemes. Wherever possible, each data element should be explicitly verified, by calculating check digits, and by utilizing other independently available data validation checks.

A number of different application “signature” formats may be implemented within a bar code scan line, as a series of successive embedded “signature” data fields. In one embodiment (Example Method M), each signature data field consists of three elements: a format designator (“fd”) consisting of one or more digits; a data field (“data”) consisting of one or more fixed or variable length sub-data fields; and a check digit algorithm (“cd”) associated with the format designator and the level at which it appears.

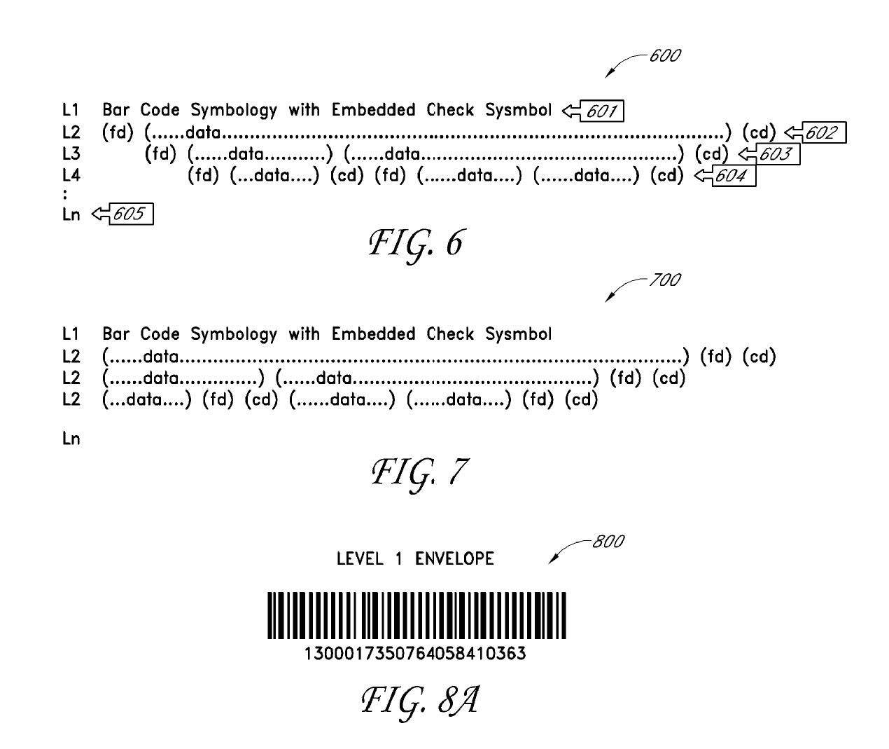

FIG. 6 illustrates a bar code “signature” 600 in one embodiment of the disclosure, utilizing four levels of successive embedded “signature” data fields. The Level 1 data validation 601 is simply the hardware decode of the bar code symbology, using the embedded check symbol character as data validation—i.e., meaning “all the bar code symbols were detected and processed correctly.” Applicability of the data to the intended target application is determined by successfully completing all the remaining levels of validation. As shown in FIG. 6, Level 2 data validation 602 consists of one signature data field (although it could have had more). The data validation of the Level 2 signature data field consists of two checks—that the format designator value (for that level) is correct, and that the check digit calculation for the data string (consisting of the format designator digit(s) and the data field digits) matches the check digit character. The Level 2 format designator defines at least three characteristics: the check digit algorithm implementations (in this example, 1), the number of data elements (in this example, 1), and the number of trailing discard characters for bar code odd/even count padding (in this example, 2). The number of unique combinations of the above three characteristics will determine the number of format designator values required at this level. For this example, there are: only one check digit algorithm used to disambiguate target applications; only one data field element; and two padding character combinations for the Code 128 bar code. Thus, the total number of format designator values required at this level is two.

The Level 3 signature data field 603 checks operate on the residual Level 2 data. The Level 3 data validation checks are similar to the Level 2 checks and the format designator defines at least these three characteristics: a) the check digit algorithm implementations (in this example, 1); b) the number of data elements (in this example, one fixed, one variable or fixed); and c) the field lengths for one or more data elements. As shown in FIG. 6, there are two data element fields. The number of data splits defined for this data field would determine the number of format designator values that are required for this level.

The fourth 604 to nth 605 levels comprise a continuing iterative process analogous to Level 3. The attributes or properties that one arbitrarily assigns to the data (and hierarchical functions) at each level determine the number of format designator values required at that level.

The target application receives all the data fields yielded by the final level of data validation, i.e. the nth 605 level.

A carefully chosen set of conventions for the format designators at each level will facilitate correct data field parsing. The additional security provided by multiple levels of check digit validation will ensure data integrity and “positive ownership” to the target application. The format designator digit(s) do not necessarily have to be leading, as illustrated above; an alternative format for the leading format designators could be as is illustrated in the bar code signature 700 of FIG. 7, in which the data strings precede the format designator digits. Those skilled in the art will recognize that this use of format designators is sometimes termed “magic numbers”, a widely used technique for attempting to classify a given unknown data structure. The need for “positive ownership” makes the judicious choice and use of format designators a key design goal for any implementation.

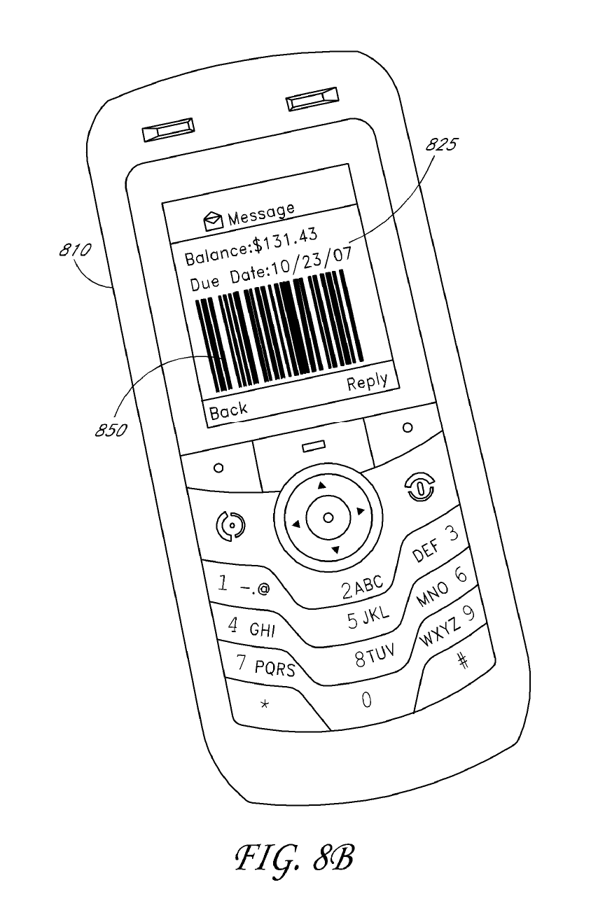

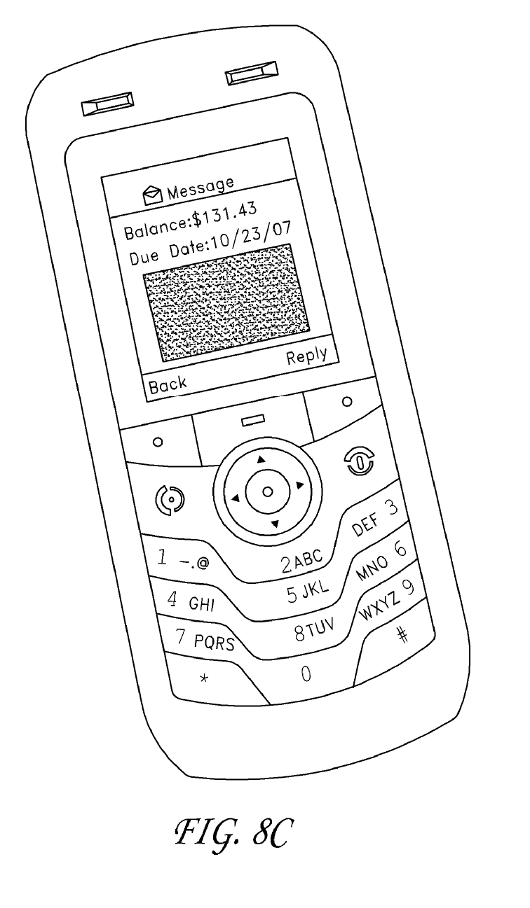

With reference to the exemplary embodiment shown in FIG. 6, a sample format of the unique bar code bill payment “signature” 800 is shown in FIG. 8A, as a multiple layered data validation scheme. A bar code typically consists of 6 sections: (1) a quiet zone (.about.0.25″ of white space) before the bar code; (2) a unique bar code symbol that represents the “START” character; (3) bar code symbols representing data characters (1300017350764058410363); (4) a bar code check symbol that represents a calculated check digit of the preceding data character block; (5) a unique bar code symbol that represents the “STOP” character; and (6) a quiet zone (.about.0.25″ of white space) after the bar code. This represents a Level 1 “envelope.” If the hardware decode of this Level 1 envelope data string is not successful, the retail cashier should not get a good bar code scan confirmation. If the hardware decode is successful, the retailer cashier should get a good bar code confirmation (but not necessarily of a valid product code). In other words, a good hardware decode of a bar coded scan line is defined as the detection of valid bar code symbols within the string that, when processed through the defined check digit algorithm, produces a result that matches the embedded string check symbol character. This is the first level of data validation check that must pass. When the bar coded data characters are decoded from this scheme of variable width white and dark bar patterns, the result is the following string of (alpha)numeric characters: 130001735076405841036 3.

It is important to note that the bar-coded “signature” can exist in many different forms. In this regard, an exemplary bar-coded “signature” according to an alternative embodiment is illustrated in FIG. 8B. In this embodiment, electronic invoice 825 is displayed on cell phone 810. This electronic invoice includes bar-coded signature 850, consistent with to the present disclosure. According to this embodiment, a cell phone user receives and/or accesses invoice 825 through an account information retrieval function on cell phone 810. The cell phone user then places the screen of cell phone 810, including bar-coded signature 850, within close proximity of a bar-code scanner. The scanner reads this invoice surrogate, and payment processing is initiated according to systems and methods consisten with the present disclosure. In another alternative embodiment, the cell phone screen can display a 2-D bar code, as illustrated in FIG. 8C. In another embodiment (Example Method N), the electronic invoice can be displayed on another device such as a PDA (personal digital assistant), a portable media player (such as the iPod®), or any other portable consumer device with an electronic display screen. Such embodiments utilize a mediating technology to create a surrogate invoice presentation, suitable for processing via systems and methods consistent with this disclosure.

Another class of alternative embodiments relates to the translation and presentation of textual payment data as a bar-coded “signature.” In these embodiments (Example Method O), necessary payment data is 1) extracted from an alphanumeric text source, 2) placed in a canonical format, and 3) converted to a bar-coded “signature.” Any text source may be used to create such an embodiment, such as (for example) electronic transactions, computer data files, or the result of processing paper or other documents via imaging, zoning, OCR (optical character recognition), and/or related technologies. The resulting bar-coded “signature” provides an unambiguous representation of such a payment transaction, regardless of the source data's medium, data format, character set encoding(s), font(s), or other characteristics. As with Example Method N, above, such embodiments utilize mediating technologies to create invoice surrogates, as described herein.

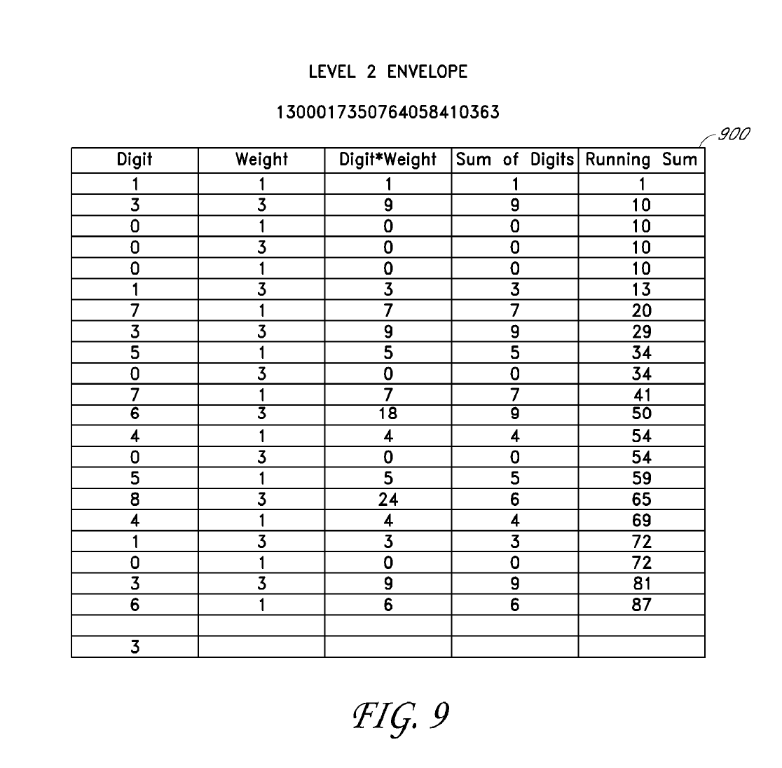

With reference to the exemplary embodiment shown in FIG. 8A, a table of calculations that determines a split modulus 10 check digit for the string to match against the last character (using a 1313 . . . mathematical weighting scheme) is illustrated in FIG. 9. The Level 2 format designator value (1) is chosen to indicate the check digit algorithm (Split Modulus 10 with mathematical weights of 1313 . . . ), the number of data field elements (1), and number of trailing padding characters (0) to utilize the high density Code 128 Type C symbol set. The Level 2 format designator value (2) is chosen to indicate the check digit algorithm (Split Modulus 10 with mathematical weights of 1313 . . . ), the number of data field elements (1), and number of trailing padding characters (1) to utilize the high density Code 128 Type C symbol set. The modulus (i.e. the remainder) of the resulting sum of the digits (87 divided by 10) yields 7. The ten's-complement of the remainder 7 yields 3 (10−7=3). This calculated result is the check digit of the above digit string, and successfully matches the last digit in this illustrative example. This is the second level of data validation check that must pass. If this validation is successful, the operation proceeds to the Level 3 envelope data decode and validation algorithms. Those skilled in the art will recognize that many different check digit algorithms and other verification methods are in current use, and others could easily be developed, any of which would provide an analogous means of data validation that would be consistent with this disclosure.

In this particular example, there are only three levels of validation defined. The Level 1 check is a hardware validation data check. The Level 2 check is a pre-qualifying software validation data check. The Level 3 check is an “ownership” data check (i.e. whether this is the “signature” for bill payment data under the present disclosure). Different “signatures” can be constructed for any number of application program uses, through a judicious design scheme and the selection of appropriate format designators. Format designators are arbitrary indicators with which to properly decode the format of, and to validate, the ensuing data string. In this case, the format designator is placed as the first (one or more) leading digit(s). At different levels, the same format designator values could have different meanings. Those skilled in the art will recognize that such choices are arbitrary implementation details.

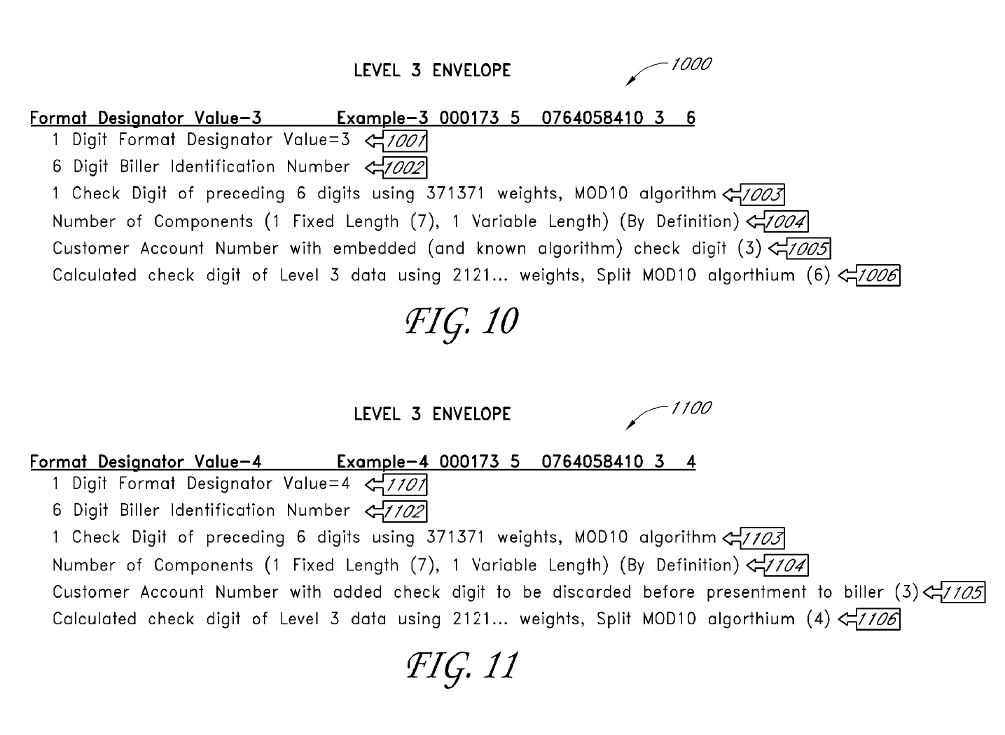

Turning now to FIGS. 10 and 11, two format designator values have been chosen in this example (at Level 3) to encapsulate six format and validation data characteristics—all of which must be correct for the third and final data validation check to pass. The Biller ID in each of these examples is “173”, in a 6-digit numbering system. (The embedded spaces in the encoded data examples 1000 and 1100 of FIGS. 10 and 11 are not significant, and are inserted to show more clearly the various fields within the example digit strings.) The six format designator characteristics shown in FIGS. 10 and 11 define either format characteristics (1, 2, 4, 5) or data validation characteristics (1, 2, 3, 6). A format characteristic defines the layout of the data, whereas a validation characteristic facilitates data checking. To validate a unique bar code application program “signature”, the more dependencies that exist within the data at each level for subsequent cross checking and validation, the better. In the illustrations of FIGS. 10 and 11, there are two format designator examples, showing all possible variants within several constraints that are checked and validated. Where there might be several different Level 2 check digit algorithms employed, a Level 3 dependency is checked. Condition #1 is checked against valid range of format designator values for the current Level (in this case 3, 4). Biller Identification Number (in this example, 173) is determined if Condition #3 is TRUE and if it exists within the list of current and valid billers (an independent table acquired by other means). Where the biller account number check digit algorithms are not known, an external check digit is calculated and added to the account number—to be checked, and then stripped, when presented to the biller (Format Designator Value=4). Where the biller account number check digit algorithm is known, it is checked against biller defined specifications (Format Designator Value=3): Conditions #1, #6. Within the Level 3 envelope for each of the above examples, the decoded and check-digited results of the Biller Identification Number and of the presented Biller Customer Account Number are as follows: For Format Designator Value=3, Biller ID=173, Customer Account=07640584103; and for Format Designator Value=4, Biller ID=173, Customer Account=0764058410. This is the third level of data validation check that must pass. If all the components in the Level 3 envelope test and compare successfully, then the unique bar code bill payment “signature” has been correctly validated for further processing, An indication is thus given to the retailer or cashier that a dollar amount payment should be entered for this item.

As discussed above, the primary goals of this bar code “signature” design are: a) to unconditionally identify the detected scanned bar code as being proprietary to a system or method consistent with to the present disclosure (in the absence of any other external information); b) to validate all the data element components therein, using mathematical formulae and/or independent table look-up methods, if possible; and c) to provide an easily-portable, monolithic image that unambiguously represents a payment destination, suitable for use on printed invoices, in surrogate invoices, and for presentation via analogous mechanisms consistent with the present disclosure.

The methods and procedures by which the format designator and other “signature” concepts described herein could be extended in a given embodiment are strictly implementation issues of design schemes, reflecting an adopted set of orthogonal conventions. While the foregoing illustrative working example uses only three levels of “envelopes” to validate the unique bar code bill payment “signature”, more levels could have been used, as required, and as shown in earlier examples. The format designators in the foregoing example utilized a fixed data format with a set of predefined check digit algorithms for each level. Possible design extensions in further embodiments might include: (1) a format designator design scheme that defines a dynamic variable number of sub-field elements and/or a set of dynamic component string lengths for each element in the defined set of sub-fields (in contrast to the foregoing illustration of predefined fixed schemes); (2) a format designator design scheme having more than one digit in length, wherein each digit specifies an independent set of predefined orthogonal attributes that can be combined in a mix-and-match fashion (e.g. a two digit format designator could specify a primary set of attributes in the tens digit, qualified by a secondary set of attributes in the units digit); and (3) format designator design schemes wherein subsequent trees of sub-field elements are controlled by one or more preceding levels of format designators.

### Bar Coding Specifications

The bill payment application bar code printed on each bill remittance stub might minimally consist of four basic fields, printed as a single string of digits (Example Method P): a format designator (1 digit); a biller identification number with optional embedded check digit (7 digits); a customer account number with optional embedded check digit (22 digits); and a check digit of the previous three fields (1 digit). Of course, those skilled in the art will recognize that the number of fields and/or digits per field as described herein is specified by way of example, and not limitation, and that the number and length of fields may vary to suit the specifics of a given embodiment of the disclosure. In this example, the outermost bar code envelope for this information conforms to documented ISO bar coding convention standards, utilizing an embedded check digit algorithm to verify the integrity of the entire bar code scan line data. It is strongly recommended that the biller-defined customer account number also contain an embedded check digit, as a prudent secondary validation measure. If an embedded check digit does not already exist within the biller customer account numbering scheme (or if the biller does not wish to disclose that information), an alternate account number format provides a temporary check digit that is checked and then discarded before presentment to the biller. If the detected bar code scan line data correctly passes the triple tiered and multiple embedded check digit calculations, this mechanism will virtually guarantee “defect free” biller and customer account data consistent with the source document. This ensures that a bill payment stub whose bar code has been mutilated or defaced by the customer will immediately be rejected at the point-of-sale.

To accommodate future requirements, an expanded set of format designators could define new data format structures, or redefine the characteristics of current data fields. The following is a possible list of characteristics that a format designator element might define within a digit string: a) number of sub-field elements; b) component string lengths of one or more of these sub-field elements; c) check digit algorithms to be applied to each of the sub-field elements; d) odd/even string packing factors for when a single bar code character represents one or more digits (Code 128 is a good example of this compression feature); or e) subsequent trees of dependent sub-field elements. These format changes would be transparent to the end user (i.e. to consumers, billers, and retailers). The bar code data, detected by the retail checkout scanner, is validated and converted to payment data automatically. Transaction details printed on receipts, submitted to billers, and visible to other users of the system, would not include any of this “overhead” data, used internally to ensure scanning and processing reliability.

The bar code might either be printed vertically on the left hand side (bottom to top) or right hand side (top to bottom) of the bill remittance stub, with sufficient surrounding white space to satisfy the criteria of the ISO bar code format. If there are other proprietary bar codes present on the bill remittance stub, the checkout counter cashier could have the option of folding or bending the bill remittance stub, such that only the required bar code is visible for a successful bar code scan of the bill payment information. Using vertically printed bar codes of the format designator, the biller identification number and the customer account number on most bill remittance stubs would permit a combined number sequence of 14-25 digits at the lowest common denominator bar code print resolution (i.e. a nominal bar code “X” dimension ≧0.010 inches, and total bar code string length ≦3.0 inches). For longer text sequences, it is recommended that the bar code sequence be printed parallel to the horizontal OCR line, such that extraneous proprietary bar code information can be folded out of the way for a successful scan.

The assigned biller identification number is acquired or distributed from a central registry authority, akin to the manner in which the Uniform Code Council assigns new producer identification numbers. As far as the customer account number is concerned, it is recommended that the biller include a check digit within the account numbering scheme. It is unlikely that a customer account number would be read in error if the hardware bar code check symbol scan validates; however, this additional check digit provides double assurance to the biller that the customer account number has been transmitted correctly. This is especially important from the biller's point of view when accepting bill payments from many sources of ACH submitted data, many of which may be human-entered from the myriad of home banking software packages available—known empirically to have very high human input error rates.

To this point, it has been tacitly assumed that the biller will want to print this new bar code on the face of the bill remittance stub. However, for technical as well as political reasons, it may be impractical to print a new bar code on the face of the current bill remittance stub. An alternative option might be for the new bar code to be printed either: a) on the back of the current bill remittance stub, so as not to disturb the current mode of visual remittance processing; b) printed on a second or subsequent tear-off bill page, formatted for that specific purpose; or c) printed on a separate enclosure page, perhaps on card stock or laminated, to permit multiple reuse by the customer. This third option would be analogous to a retailer preference card. Spare space on a separate enclosure could even be sold for advertising, to defray printing costs by the biller.

The most common point-of-sale bar code used throughout the retail industry is the UPC-A variant. However, most scanners employ an internal firmware auto-recognition mechanism to detect and read several bar code symbologies. The Code 128 family symbology may be the most general specification of an alphanumeric customer account number. Where there are only numerics, the Code 128 Type C variant features a high-density bar code—with one printed symbol per two digits of information.

During the checkout aisle scanner process, when analysis of the bar code “signature” recognizes a bar code data scan line as a valid bill payment transaction, the cashier is asked to enter an amount to be paid. When this amount is entered, a fixed transaction fee is added to the bill payment amount. On the printed customer receipt, the bill payment is recorded in a form similar to the following, including biller name and account number, amount paid, transaction ID, date and time, and transaction fee charged:

PMNT: Biller Name

ACCT: Customer Account Number

AMNT: $ ddd.cc

TRID: rrrrrrr yjjj ssss

DATE: mm/dd/yy hh:mm

FEE: $ dd.cc

This time-stamped transaction data is then transmitted to the transaction collection system.

When a bill payment stub contains multiple bar codes, the retailer cashier may scan the wrong bar code, causing the payment to be rejected at the point of sale. For a given bill type, the retailer cashier can be trained to recognize the placement of the valid bill payment “signature” bar code, which must be scanned for the proper processing of a customer payment. Scanning any other bar code present on the bill remittance stub will result in an immediate rejection, since it would not pass all of the bill payment “signature” tests.

### Back-End Host Processor

The retailer back room host processor (or equivalent functionality provided within a point of sale or other system) may be required to support two well-defined interfaces: a) the front-end checkout counter scanner system; and b) the back-end data collection network interface. These in turn may be implemented as separate components, or may be integrated with the point of sale system.

When a bill payment bar code (e.g. a Code 128 bar code as described earlier) is encountered from a bill remittance stub, the back-end host processor component is used to determine that this is a customer bill payment, rather than the UPC code for a customer selected product. This test can be performed in a number of ways by the back-end host processor. The easiest logic path to implement within the back-end host processor is as follows: If this bar code scan is not recognized as one of several defined pre-programmed sequences corresponding to retail product purchases, then pass the code to the data collection network interface (DCNI, described below) before rejecting the scanned data completely. The back-end host processor passes the complete scan line data to the DCNI for secondary level validation and data translation. If secondary level validation is successful, the parsed translated data is passed back to the back-end host processor, which then completes the processing for this bill payment transaction. In this case, the returned translated data consists of: the Biller Name; the Customer Account Number; and a Transaction ID. This information is printed on the customer printed receipt at the point of sale.

As bill payment data is processed by the front-end checkout scanner system and completed, it may be relayed by the back-end host processor to the DCNI, to be stored in non-volatile memory for later transmission to the central transaction collection system. There are a number of standard data collection network interface functions that may be accessed by the back-end host processor system and incorporate in a given retailer's payment process flow, e.g. validating the biller name, adding a transaction, voiding a transaction, printing daily or weekly processed totals and reports, and setting or reading operational configuration parameters.

### Data Collection Network Interface (DCNI)

The retailer's back-end host processor system and/or point of sale system must communicate with a data collection network interface (DCNI), which is used to access the payment network by which transactions are sent to billers. This interface can be implemented in various ways, e.g. as an in-store hardware component, or as an extension to either the back-end host processor system, a point of sale system, or a transaction collection system residing on a network processor's server. Regardless of its implementation, the DCNI should provide a well documented, protocol-neutral linkage, connecting the retailer's back-end host processor function with the transaction collection system. For reliability, and to avoid the risk of transaction loss in abnormal circumstances, the DCNI should also provide a non-volatile memory storage capability for accumulated customer bill payment data. In an in-store hardware device, this may be accomplished with a solid state hardware design that is electrically isolated at all the critical interfaces, and has no moving elements that mechanically wear and might eventually cause the unit to fail. With other implementations, data reliability can be ensured using various checkpoint, journaling, and other techniques that will be familiar to those skilled in the art. The back-end of the data collection network interface should provide a transparent interface to the transaction collection system, however and wherever it is implemented, and should include functionality such as: (1) performing secure validation procedures with the transaction collection system; (2) downloading DCNI hardware-specific elements if required, such as unit operating system and program application code firmware, and setting system date/time; (3) downloading DCNI operational configuration parameters; (4) uploading hardware-specific elements if required, such as DCNI unit memory image for emergency and debug use; (5) downloading Verification Biller ID and Name data; and (6) uploading transaction data (compressed and encrypted). The primary function of the DCNI is to provide a set of support functions to the retailer host processor to aid in the collection, validation and storage of transaction data from customer bill remittance stubs, as they are scanned at the checkout counter.

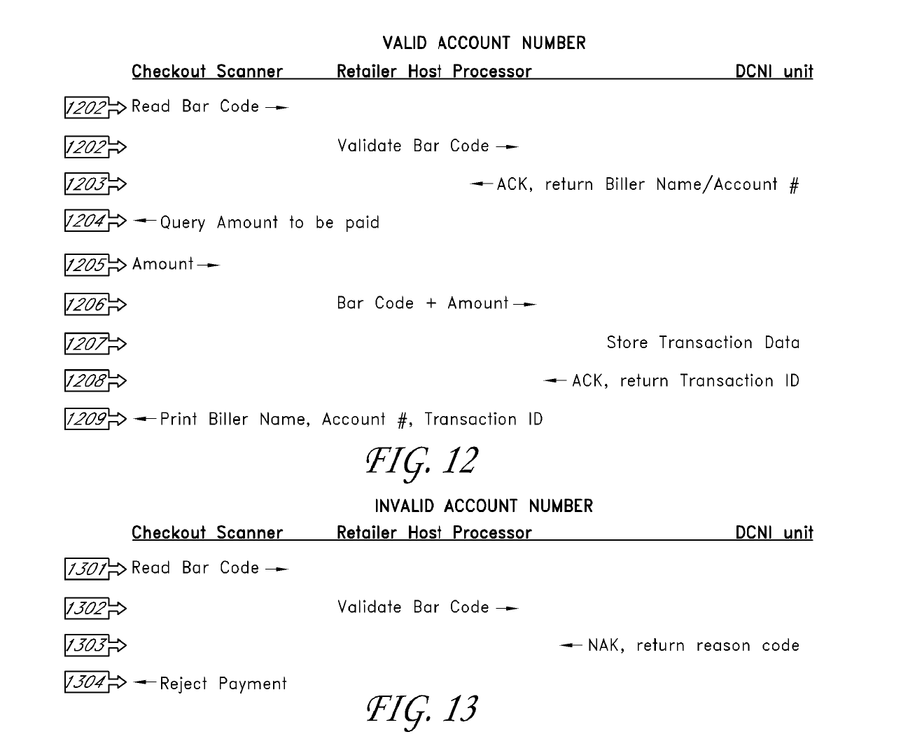

FIGS. 12 and 13 illustrate the mainline transaction information interchange between the checkout scanner, retailer host processor, and a representative DCNI unit in processing a bar coded customer bill remittance stub, in one embodiment of the disclosure. As shown in FIG. 12, the interaction occurring in the case of a valid account number begins with the bar code being read 1201 by the checkout scanner and passed to the retailer host processor. The host processor next validates the bar code 1202 and passes the resulting data to the DCNI. Since the account number is valid, an acknowledgment of validity (ACK) is returned 1203 via the host processor to the checkout scanner, along with the biller name and account number. The amount to be paid is queried 1204 at the checkout scanner, and the amount entered is passed 1205 to the retailer host processor, which passes 1206 the bar code data and the amount entered to the DCNI, where this transaction data is stored 1207. If the data store is successful, an acknowledgment is sent 1208 via the host processor to the checkout scanner, along with a transaction ID number. The checkout scanner may then print 1209 the biller name, account number, and transaction ID as a transaction receipt.

As shown in FIG. 13, in the case of an invalid account number, the checkout scanner first reads the bar code 1301 and passes it to the retailer host processor. The host processor next validates the bar code 1302 and passes the resulting data to the DCNI. In this case, since some aspect of the data passed to the DCNI was invalid, an acknowledgment of invalidity (NAK) is returned 1303 to the host processor with a reason code. The Reject Payment status, passed to the checkout scanner 1304 from the host processor, may or may not contain the DCNI reject reason code for human feedback. Reason codes might include, e.g., invalid scan line (not a valid bill payment “signature” scan line), Biller ID check digit error, invalid Biller ID (old biller that is not serviced anymore), or Biller Customer Account Number check digit error. Payment is consequently rejected at the checkout scanner 1304.

In one embodiment (Example Method Q), the Transaction ID that is returned to the retailer back-end host processor, as a positive confirmation that the transaction data has been accepted and successfully stored, is a 15 digit number consisting of: DCNI identification (7 digits), last digit of year (1 digit), Julian date (3 digits), and transaction sequence number (4 digits). This information may be printed on the customer receipt as three groups of digits (7, 4, 4) to address an ease-of-use issue, should it be necessary for the consumer to dictate a Transaction ID to a customer service representative over the telephone.

Periodically throughout the day (primarily based on time and transaction volume thresholds), the DCNI should transmit stored data to the transaction collection system after it has aged past the “transaction void” window. The “transaction void” window is defined as the time past which the transaction cannot be canceled after it is taken (e.g. 15 minutes, to eliminate the possibility of fraud). In one embodiment (Example Method R), the data elements of each transaction transmitted to the host consist of the following fields: Retailer ID; Biller ID; Biller Account Number; Amount Paid; Sequence Number; Transaction Date/Time Stamp; Status (Active or Void); and Operator ID. When such transactions are transmitted to the transaction collection system, they may be sent in batches, whose batch names conforms to the following naming convention: DCNI identification (7 digits); last digit of year (1 digit); Julian date (3 digits); and last transaction sequence number in batch (4 digits). Such a numbering convention makes it easier for customer service operations personnel to trace a given Transaction ID.

In different embodiments of this disclosure, the data communication network interface could connect to the transaction collection system using either a real time on-line architecture or a batch oriented architecture. If implemented as a real-time system (Example System S), where transactions are sent continuously, then high-bandwidth communication to the central site will be important, as well as a redundant “hot cutover” central site hardware configuration, to eliminate all risks of single point equipment failures or lost transactions. Such architectures are comparatively expensive to equip and operate. Their requirements and costs are very well documented, and will be familiar to those skilled in the art. A batch architecture (Example System T), where transactions are sent in groups, can eliminate the real-time aspect of transaction processing that exponentially escalates costs. Central site redundant hardware with “hot backup” would still have to be available, but much less of it is required to achieve the same level of system operation reliability. Unlike true real-time systems, e.g. credit card verification, retail payment processing can withstand moderate latency in abnormal circumstances without negative user impact—e.g. an occasional delay of minutes or even hours before posting would be acceptable. A batch configuration is thus appropriate for consideration. For example, in one embodiment (Example System U), the DCNI expects explicit acknowledgement of all transaction batches, and automatically resubmits any batches not explicitly acknowledged as processed. This operation may occur after a delay of minutes to hours. Subsequently, if duplicate transactions are encountered on resubmission, they are not processed by the transaction collection system, but are acknowledged as processed to the DCNI. Much less premeditated contingency system software is required in such a batch-oriented environment for robust system operation.

### Transaction Collection System

In different embodiments of this disclosure, the central site transaction collection system may consist of either one computer system, a component of a network processor's server(s), or multiple server units acting in concert to perform a collective set of functions and processes. A multiple-server design is used in the examples below. This approach permits scaleable processing, and avoids the possibility of single-point failures that might curtail or impact the production processing of incoming transaction batches. (A network processor, implementing these transaction collection system functions within its existing server architecture, would need to address similar functional requirements.)

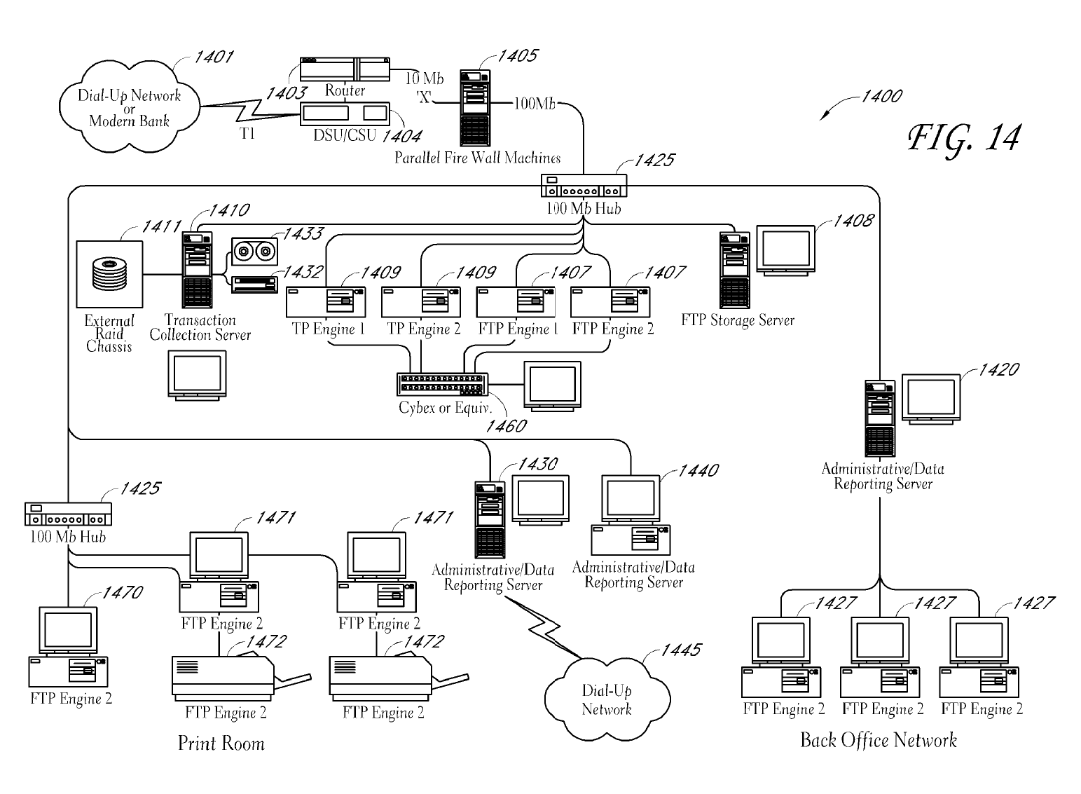

FIG. 14 illustrates one possible configuration for the transaction collection system 1400. In the embodiment shown, incoming encrypted data files from the field data collection network interfaces would come through a network, e.g. a dial-up network or modem bank 1401 over a T1 or similar connection 1402, into an entry router 1403 outside the central site firewall, via a channel service unit/data service unit 1404 (CSU/DSU) or other similar device for providing isolation between the network and the on-premises equipment. Note that a conventional Internet connection could also be used in place of these elements. Parallel firewall machines 1405, one operating in “hot back up” mode, filter the inbound data traffic arriving from validated and secure data sources. In addition to their primary security role, one of the ancillary functions of the firewalls 1405 is to load balance the data traffic across a “server farm” containing file transfer protocol (FTP) engines 1407. A plurality of FTP engines 1407 are shown in the diagram as being in a scaleable multi-server configuration, coupled via one or more integration hubs (e.g. 100 MB or 1 GB Ethernet hubs) 1425. The FTP engines 1407 provide the raw computing power to transfer data packets from the firewalls 1405, to coalesce the data packets into data files, and to write them to the FTP storage server 1408, which may comprise RAID (redundant array of inexpensive disk) storage or similar mass storage.

In the FTP storage machine 1408, a monitor process scans for completed inbound files to process. Upon finding such a file, the file decryption keys are fetched from the central transaction collection server 1410, and the file name is packaged in a message packet that is sent to one of a plurality of transaction processor (TP) engines 1409 in a scaleable multi-server configuration, all coupled via one or more integration hubs 1425. It is noted that the transaction processor engines 1409 and FTP engines 1407 may optionally be provided with a console switching unit 1460 (often called a KVM) for sharing a single console (e.g. monitor, mouse, keyboard) across the plurality of engines 1407, 1409. A transaction processor engine 1409 (TPE), upon receiving this message packet, then has sufficient information available to locate, to decompress, and to decrypt the inbound data file into its component data record types. The various received data record types are stored in a database (e.g. one accessed via Structured Query Language, or SQL) on the transaction collection server 1410. The transaction collection server 1410 database is configured across several partitioned sets of physical hardware 1411 set up for RAID storage operation. The primary purpose for spreading the databases over several pieces of physical and logical hardware and/or software is to avoid having single points of data congestion and equipment failure. The transaction collection server 1410 database is the destination for all the data collected at all the retail processing locations. On a scheduled production basis, the data is aggregated and sorted, according to the biller identification associated with each transaction customer account number. ACH transaction files are prepared and formatted by biller identification, which in turn maps into biller-designated destination ABA bank routing and bank account numbers.

The administrative/data reporting server 1420 provides access to a copy of the production data for back office operations and monitoring by one or more work stations 1427, without burdening the front end collection system. In the embodiment shown, one or more 100 MB or 1 GB Ethernet hubs 1425 interconnect the various servers. This technology allows network elements to communicate and to access each other's mass storage as local devices. The web/fax server 1430 provides on-demand reports to retailers, through a web server application. It also provides periodic reports to retailers that can be faxed out through the normal public telephone network 1445. The electronic transmission interface (ETI) machine 1440 prepares the data that has been accumulated and processed by the transaction collection server 1410 for transmission to the Federal Reserve ACH Network. It formats the data into the correct ACH CIE (customer initiated entry) format, and transmits this data file to the appropriate destination bank interface. An optical drive 1432, tape storage unit 1433, or other such storage means may be provided for creating removable backups, which may be stored off-site.

In the CIE Entry Detail Record format, the following exemplary fields are populated with bill payment information: AMOUNT (Field 6) is populated with the Customer Payment; INDIVIDUAL NAME (Field 7) is populated with the Transaction Sequence Number (which contains the Julian date of payment); INDIVIDUAL IDENTIFICATION NUMBER (Field 8) is populated with the Biller Customer Account Number; and DISCRETIONARY DATA (Field 9) is populated with the Payment Complete Time encoded as a two digit time field ranging from 00 to 95. This number may be divided by 4 to calculate military hours (decimal) to the nearest quarter hour. For example, the number 26 divided by 4 would yield 6.5 (0630 or 6:30 AM). The remaining fields in the CIE Record format are populated with mandatory banking information data, such as biller ABA and account number.

A print control station 1470 is coupled to one or more print engines 1471 for handling printer transmissions to one or more laser printers 1472 for a variety of report and other printing functions.

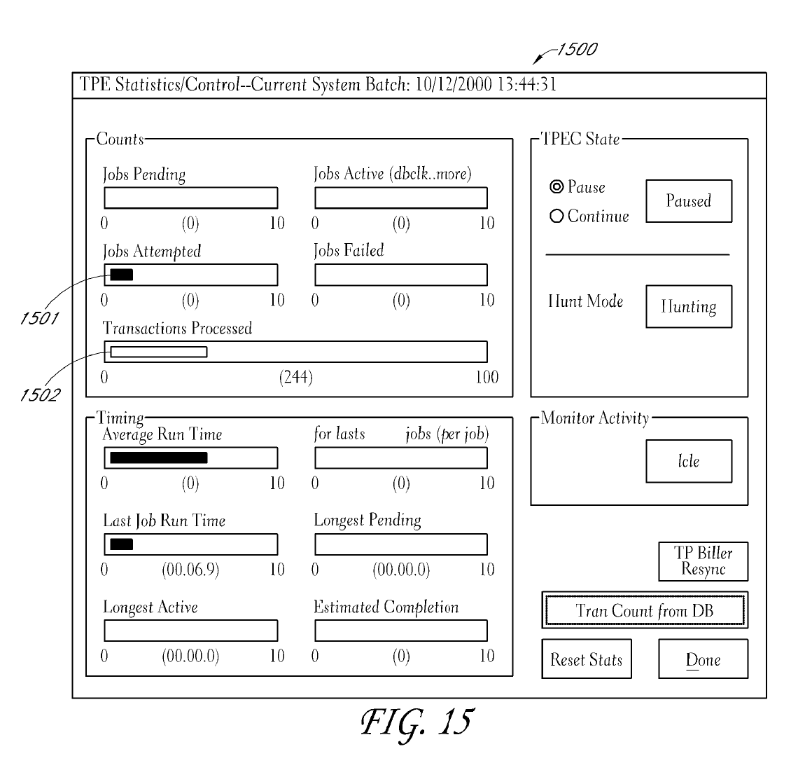

FIG. 15 illustrates an exemplary transaction processor executive controller (TPEC) display screen 1500, in one embodiment of the disclosure. The TPEC monitor program resides in the FTP storage server 1408, and is responsible for detecting complete inbound data files from the field retailer based data communication network interfaces (DCNI, described above). When an inbound data file is detected, TPEC fetches the file decryption key from a master database and then dispatches it and the data file name to one of the transaction processor engine (TPE) 1409 program threads. The TPE 1409 decompresses and decrypts the inbound data file, and stores the component plain text data records in the SQL database that resides within the transaction collection server 1410 on RAID storage 1411. As shown, display screen 1500 may include features such as jobs attempted 1501 (i.e. batches received) and transactions processed 1502 (i.e. individual data records processed from the batches received). This display 1500 shows the current Transaction Process Engine(s) batch job statistics for the system batch dated Oct. 12, 2000 at 13:44:31. As shown, TPEC is in PAUSEd State—it is not currently dispatching any detected inbound data files to the TPE engines 1409. For this batch, 129 inbound data files were processed, resulting resulted in 244 data records, stored in the SQL database.

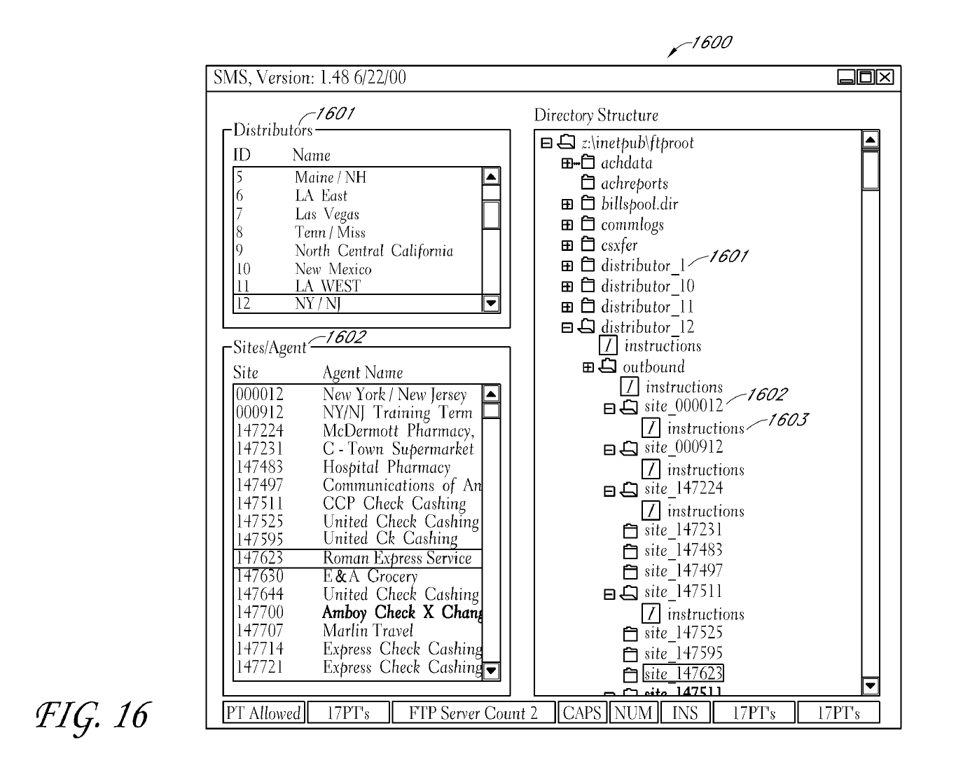

FIG. 16 illustrates an exemplary system monitor station (SMS) display screen 1600, in one embodiment of the disclosure. This display 1600 shows that individual retailers may be configured in a directory-tree-like structure, with each of a plurality of distributors 1601 being a parent to one or more retailer bill pay sites 1602. The directory framework of retailers 1602 may conform to any convenient form of administrative structure, e.g. a distributor model, based on a hierarchy of people, or a physical model, based on territories with defined boundaries (states, counties, or towns). Also illustrated in this display is the placement of INSTRUCTION files 1603 that can reside at any level within an arbitrary configuration structure. An INSTRUCTION file 1603 contains operational directives to be applied to retailer terminals at or below the level of placement in the directory structure (i.e. transaction pricing, unit transmission schedule, revised configuration parameters).

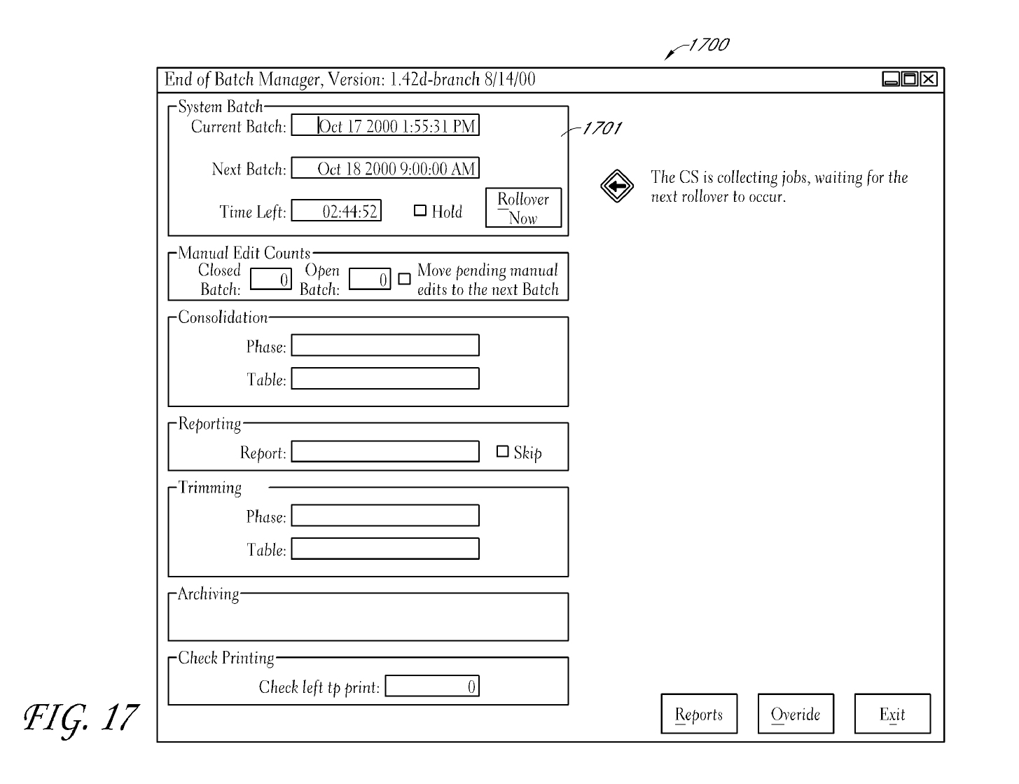

FIG. 17 illustrates an exemplary end of batch monitor (EBM) display screen 1700, in one embodiment of the disclosure. When the current system batch is closed out, this display 1700 shows the status of the various data processing phases (e.g. system batch 1701) that take place when the collection of received transaction data batches from the retail DCNIs are consolidated and sorted by biller for electronic transmission. In this embodiment, EBM is a program that orchestrates the series of Structured Query Language (SQL) scripts and ancillary programs, to perform transaction consolidation, general system batch reporting, database trimming and data archiving.

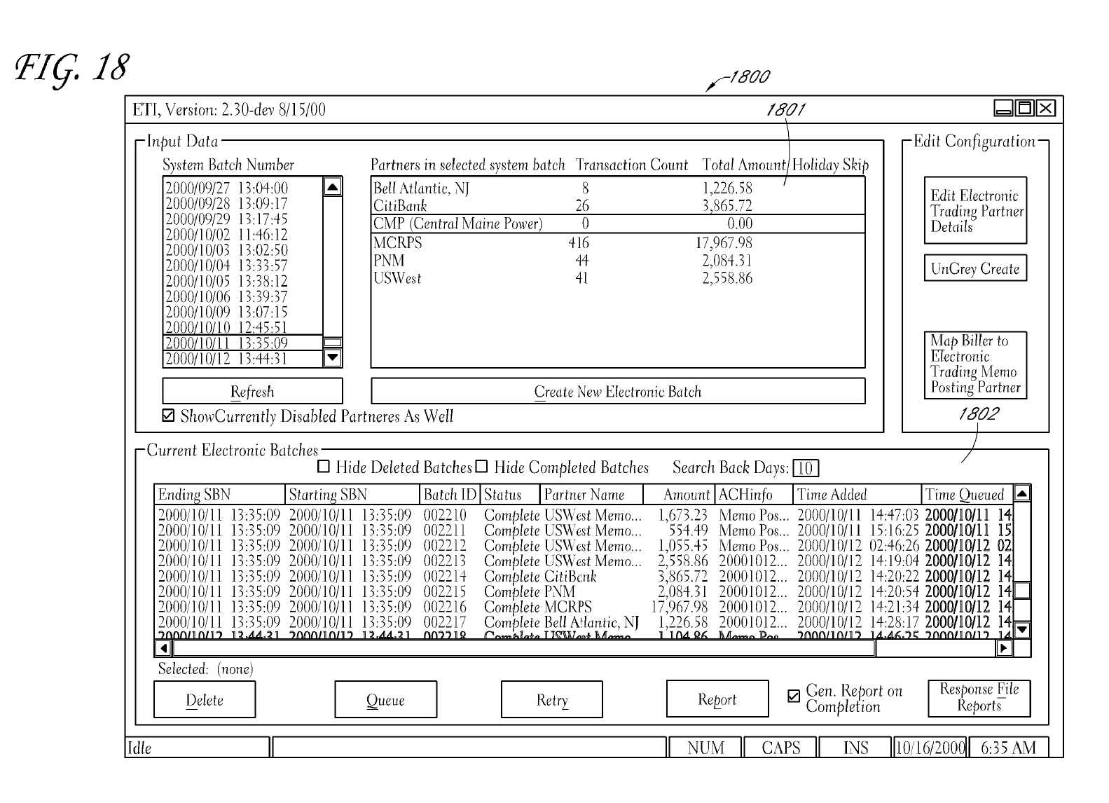

FIG. 18 illustrates an exemplary electronic transmission interface (ETI) display screen 1800, in one embodiment of the disclosure. This display 1800 includes a summary 1801 of the dollar amounts sent to each of the electronically connected remittance partners. The batch status window 1802 shows the current status of the transmission batches (QUEUED, ACTIVE, DELETED, or COMPLETED). An additional column (not shown) may be included to show the confirmed time of transmission completion.

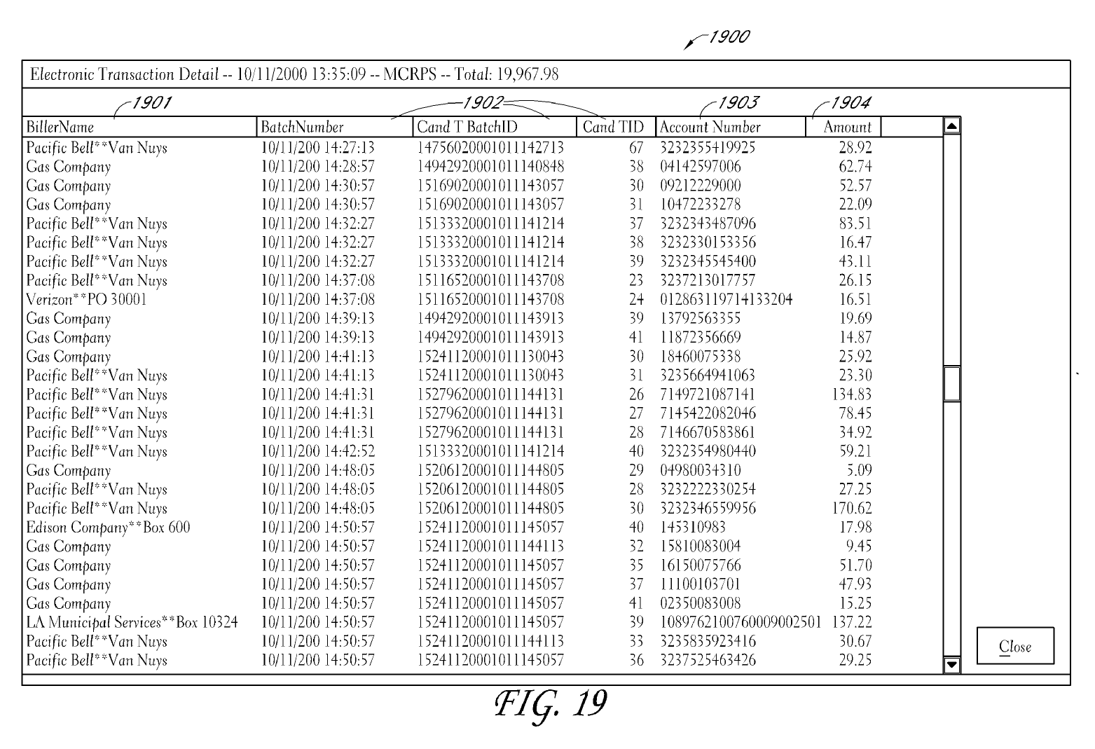

FIG. 19 illustrates an exemplary ETI transaction detail display screen 1900, in one embodiment of the disclosure. For a specific partner (in the example shown, MasterCard RPS), this display shows the details for each remitted transaction: biller name 1901; originating source transaction detail for direct traceability 1902; customer account number 1903; and amount paid 1904. From an electronic perspective, the biller is only interested in the payment amounts to be applied to various customer account numbers.

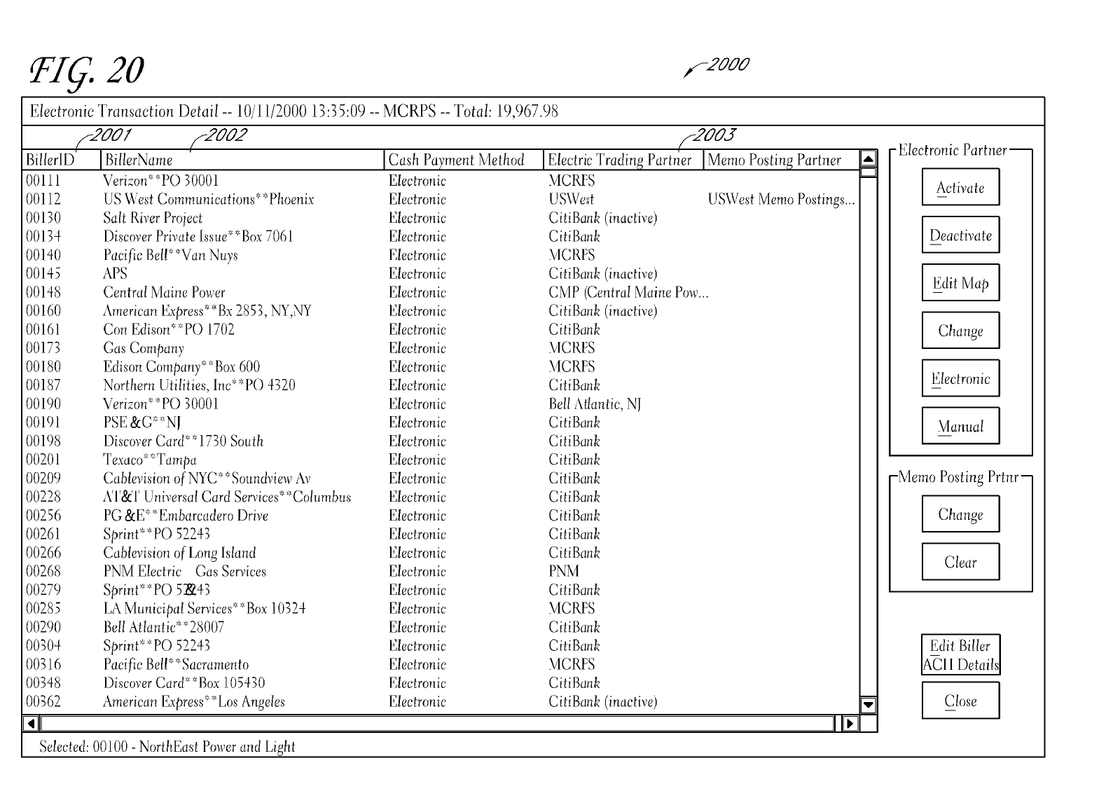

FIG. 20 illustrates an exemplary ETI map biller-to-partner display screen 2000, in one embodiment of the disclosure. For each biller defined in the system, there is a one-to-one mapping of electronic destinations. While ninety-five percent or more billers may have their remittances delivered via the Federal Reserve ACH network, the remainder of the remittances may be delivered by a combination of directly connected links and secondary consolidator links. Display screen 2000 shows, for each biller, a Biller ID 2001, and Biller Name 2002, mapped to a particular electronic destination 2003. Not explicitly demonstrated by this display is the implicit dynamic mapping of internal Biller IDs 2001 to external Merchant IDs (depending on the electronic link utilized); this mapping is needed for this system to interoperate successfully with a variety of external electronic networks. Different electronic links may also have different data formats and other parameters, as those skilled in the art will appreciate.

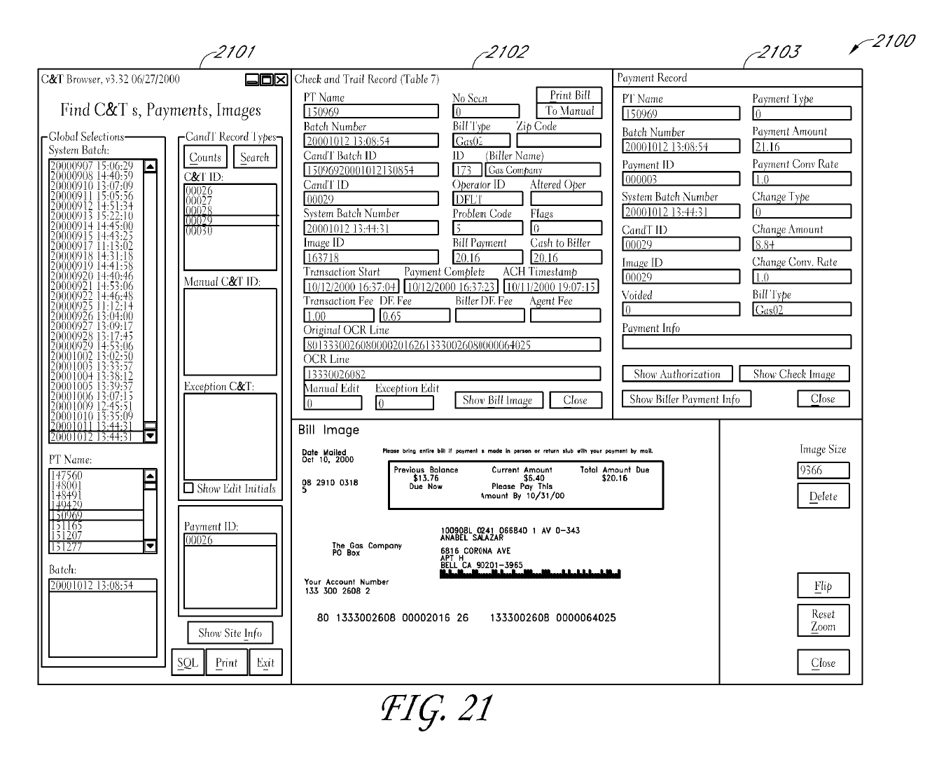

FIG. 21 illustrates an exemplary transaction browser display screen 2100, in one embodiment of the disclosure. For every transaction processed through the collection system, the transaction browser program accesses and displays all the relevant information pertaining to that transaction—either locally, or through a secure Web Server Application provided to remote billers. Such information may include, e.g., a selection entry portion 2101, check and trail record 2102, and payment record 2103. (It should be noted that the bill image would typically not be transmitted to the transaction collection system, and that it is shown in this figure for illustrative purposes only.) The system derives the biller account number from the proposed standard format of biller imprinted bar codes, as described herein.

In summary, the main goals of the central site transaction collection system 1400 are: a) to collect transaction data from the retail network; b) to sort and aggregate the data by biller; and c) to remit the customer payment data and the money to the biller via the Federal Reserve ACH Network. In the same way that customer data is collected, processed, and credited to individual billers, the ACH Network is used to electronically debit the retailers for the payments that they have collected from their customers. The transaction fee, paid by the customer, may be shared by the retailer and the transaction processor.

### Central Biller Registry System

The current state of the bill payment industry is very fragmented. Most billers currently print their own customer invoices to suit the needs of their own remittance processing systems. There is no universal invoice printing standard to which everyone adheres, because there is no economic motivation to do so. Several primary items are required for a bar coded customer bill payment system to succeed: 1) an industry standard that is relatively simple to implement, with little or no marginal cost; 2) a sufficiently large network of retail establishments, induced by the economic incentives of taking bill payments with little or no marginal cost; and 3) a method of delivering totally error-free, electronically remitted customer payment data and funds to billers at no charge.

From a business point of view, there are several organizations that, once persuaded, might provide the required motivation momentum in each of these areas. With this assumption in hand, a central registry system would be required to collect information and to assign the bar code biller identification numbers, in the same manner that the American Registry for Internet Numbers (ARIN) assigns North American Internet (IP) addresses, or the Uniform Code Council assigns UPC codes for the retail industry.

In one embodiment (Example Method V), assigned biller bar code identification numbers may be 7 digits in length. The first 6 digits identify the biller (for a maximum population of 1 million) with the 7th digit being the check digit. For every biller bar code identification assigned, the following information might be required for central collection: 1) Biller Name, Address, Phone Number, Fax Number; 2) Biller Administrative Contact Name, Phone Number, E-Mail Address; 3) Biller Remittance Contact Name, Phone Number, E-Mail Address; 4); Electronic Connection Type (ACH or Direct); 5) Bank Name, Address, Remit Account Information, Type; 6) Bank Contact Name, Phone Number, E-Mail Address; 7) Account Number Information (detailed account format specifications). Having collected the foregoing information, a biller bar code identification number would be assigned, and a set of bar code print specifications sent to the biller contact. It would then be the responsibility of the biller to print and to submit a set of test bill remittance stubs for conformance testing and validation. Conformance testing on the set of sample bill remittance stubs would ensure that the bar code image quality and physical bar code dimensions satisfied the lowest common denominator bar code scanners at retail. Validation testing would ensure that information supplied by the biller, regarding the printed bar coded customer account number, conformed to published account number validation specifications.

### Payment Time Stamp via Federal Reserve ACH Network

The INDIVIDUAL NAME field (Field 7) in the ACH CIE Batch Detail Record contains the customer payment transaction number, which is composed of the following 4 data fields: DCNI identification (7 digits), last digit of year (1 digit), Julian Date (3 digits), and the transaction sequence number (4 digits). While the DCNI number identifies the retailer where the customer payment was taken, the next four digits specify the year and the Julian date of payment submission and completion. The DISCRETIONARY DATA (Field 9) in the ACH CIE Batch Detail Record may be populated with the Payment Complete Time encoded as a two digit time field ranging from 00 to 95. As stated above, this number may be divided by 4, to calculate military hours (decimal) to the nearest quarter hour. For example, the number 26 divided by 4 would yield 6.5 (0630 or 6:30 AM). Time synchronization may be acquired from universal time standards available through the Internet or national dial-up time services (U.S. Naval Observatory, Wash., DC or the National Institute of Standards and Technology, Boulder, Colo.).

Whether or not sanctioned by a governmental agency, such as the U.S. Post Office, this time stamp could be recognized by billers and customers in much the same way that the U.S. Post Office postmark on letters is used to prove on-time submission. The customer would have printed proof of payment date and time, by virtue of a store receipt, one that a biller could not artificially manipulate for purposes of assessing penalty payments. The biller would also have electronic access to this field. Currently, the biller has no automated means by which to read the U.S. Post Office postmark for proof of on-time bill payment submission (nor is there any incentive to do so). Bill payment “due date”, as specified in the small print of every credit contract, can have a variety of individual definitions—none of which is directly visible to or traceable later by the customer. A universal bill payment time stamp would eliminate all the variability of these “due date” definitions, provided that the biller recognized this time stamp as the creditor date of receipt, as specified in the Federal Reserve Regulation Z Section 226.10.

The advantage of this date stamping mechanism to the customer is that it would give marginally more time to remit a bill payment on time to the biller. In the extreme, the customer could pay a bill payment at a late-hours store at one minute to midnight on the due date. The customer would no longer have to worry about remittance delivery times. The advantage of this date stamping mechanism to the biller is that extremely late payments may be electronically credited to the biller no later than 36 hours after customer payment. In the majority of cases, in which the biller had multiple daily bank data feeds, the credit would probably issue in fewer than 24 hours. Increasing settlement efficiency in the banking industry will only improve this situation. With such a system in place, electronically delivering and electronically applying funds, the current level of biller effort in the handling of late payments would be entirely eliminated. In the extreme case, billers could safely invoke 48-hour cut-off notices, with little or no error of service call recalls.

Electronically remitting data and money through the Federal Reserve ACH Network as described above will only work for those billers whose customer account numbers are less than or equal to 22 digits. This is due to the current maximum width of Field 8, INDIVIDUAL IDENTIFICATION NUMBER, using the standard CIE Entry Detail Record format. If a remitted customer account number is longer than 22 characters, then either one of three possible solutions is available: a) by using Field 3, 80 columns of data in the CIE Addenda Record format; b) by implementing a dedicated data link to the biller with a biller specific data format; and c) by having the Transaction Collection System generate a unique transaction serial number to store in Field 8, with which the biller could later retrieve a full account number via a service interface, either provided via web access to the Transaction Collection System, or via a dedicated link.

### Alternative Electronic Networks to Accommodate Special Billers

For high volume billers preferring to have their data delivered faster than the current Federal Reserve ACH Network delivery schedule, direct file transfer links (e.g. FTP) from the ETI machine through the Internet may be made available. File data formats and the particular delivery mechanisms may be tailored to meet any biller requirement, so long as it expedites the flow of customer payment information. In this mode of operation, biller data would be available for processing within minutes after the scheduled transaction collection system production “system roll” completes. The “system roll” sorts and aggregates biller data on a daily production schedule—in this embodiment, once every 12 hours. Payment totals for these transaction batches would be delivered via the ACH Network. For a trusted remitter, it is not typically necessary to directly couple the transaction dollars with the transaction data. The time lag between transaction data and transaction dollars via the Federal Reserve ACH Network should be no more than 24 hours.

### Improved Electronic Monetary Transaction Embodiments

The following material describes embodiments of the disclosure which improve the speed and range of electronic monetary transaction services through the use of invoice surrogates.

The embodiments described above relate, generally, to bar code based biller/payor systems for electronic bill payment. As described above, it is contemplated that, in an exemplary electronic bill payment infrastructure (e.g., see reference numeral 500 of FIG. 5) consistent with the disclosure, consumers can pay their bills at supermarkets and large retail chain stores, and receive immediate credit from billers for their payments. In such an infrastructure, the biller receives good payment funds, deposited directly into his bank account, and error-free electronic payment data for consumer bill payments by 6 AM the next business day. Contractually, the biller is required to backdate the received bill payments to the “electronic postmark” time and date paid at retail, regardless of the time that the payment data takes to post to the biller's accounts receivable system. Compared to the present paper based remittance processes commonly employed throughout the payments industry today, such an infrastructure provides for an electronic process that remits error-free payment funds and data directly to billers within hours, rather than days.

As efficient as this electronic bill payment process may be, it may not be fast enough for the needs of Internet commerce based companies, selling products to electronically connected remote consumers. The electronic bill payment process, as described above with respect to billers and payors, still depends on the biller generating a paper bar coded invoice statement, and sending it to the consumer by US Mail, a process that can take, on average, anywhere between 6-8 days. A consumer with the financial resources in hand can remit a payment directly to the biller, electronically, within hours, but must first wait for the arrival of the invoice.

In an improvement to the electronic infrastructure for this process, described below, the use of invoice surrogates, transmitted electronically, gives Internet commerce-based companies a simple new bill payment method that can reduce the time interval between biller invoice statement generation and consumer payment notification to the biller to less than an hour.

Another improvement to the electronic infrastructure for this process, also described below, adds the capability of person-to-person money transfers. Currently, there are several organizations that offer electronic person-to-person money transfers, which are available so long as the sending and receiving parties both deposit and receive their remitted funds within the same organizational network of geographically dispersed branch offices. What may be a convenient remittance location for the sender may not be so for the receiver or vice-versa. Person-to-person money transfers can be easily accomplished with a bar coded deposit slip that permits a sender to remit funds directly into a receiver's bank account. Such funds would subsequently be accessible for withdrawal at a convenient Automated Teller Machine (ATM) or for a debit card purchase.

The details of both these improvements are discussed below.

### Improved Electronic Bill Payment Network

The embodiments described in this section relate to an improved national electronic bill payment network, wherein bar coded invoice statements are generated immediately by the biller or the consumer, and remitted to the consumer in the span of seconds to minutes—via facsimile, e-mail or other image transmission method. Upon receipt of such an imaged invoice statement, the consumer, with payment in hand, may go to a local store that accepts and processes these bill payments. When the consumer payment is processed at retail, it is electronically remitted to the biller with absolute accuracy within 24 hours after receipt of payment. Electronic notification to the biller may occur within minutes after receipt of payment, with no payment repudiation.

Such an electronic bill payment network offers the following benefits: a) The biller benefits by receiving 100 percent accurate electronic bill payment information, and good funds, delivered into his bank account by 6 AM the next business day that can be directly applied to his accounts receivable. The biller further benefits by receiving an immediate electronic notification of consumer payment at retail, with funds that cannot later be retracted. As a result, billers can then ship the consumer product sooner, thereby raising consumer satisfaction levels with the biller's Internet portal. b) The consumer benefits by receiving an immediate electronically-delivered bar coded invoice statement for an Internet shopping basket of products, via facsimile, e-mail or other image transmission method. The consumer benefits because this bar coded invoice statement can be paid locally with a choice of cash, check, debit card or any credit card, without having to disclose any personal financial information to a remote Internet store. Further, local payment precludes the possibility of future fraud resulting from hackers' or others' unlawful access to any stored financial information left and residing at remote Internet stores, or that may be secretly captured on a computer being used at a library, Internet café, or similar location not under the control of the customer, or by a computer virus or spyware that may have secretly been installed on the customer's own computer. c) The local retail establishment benefits by receiving a relatively cost-free margin from each payment transaction taken. d) Finally, a national enhanced network with many retail outlets has the potential to spur the demand for yet new immediate and electronically-delivered financial products and services, using “signature” specific bar codes, and thus may generally benefit the economy of the country or other geographic area in which it is implemented.

An exemplary embodiment of the improved bar coded bill payment based system consistent with the present disclosure (Example System W) utilizes a bar code on the biller invoice, which is delivered to the customer electronically, i.e., by fax, e-mail, or, other image transmission method, i.e. an invoice surrogate. When the customer uses this image at a retail location, payment information and payment credits are returned to the biller electronically. This system may augment some elements of the biller/payor network 500 (described above with respect to FIG. 5) with faster and parallel processing elements. In this case, the biller accounts receivable and US Mail consumer remittance mechanisms may be enhanced with a new accounts receivable invoice statement image generation mechanism, capable of being activated, on demand, either by a biller customer service representative or by a consumer initiated action. The result of either action is the creation of a bar coded invoice statement image (i.e. an image surrogate) that is electronically transmitted to the consumer within a time frame of seconds to minutes. The transaction collection system described above, which already has an inherent Internet accessible transaction browser capability, may be enhanced with e-mail, facsimile, or other means of electronic notification, to alert the biller when specifically designated payments have been received. An automated caller response system may provide for consumer inquiry confirmation of payments.

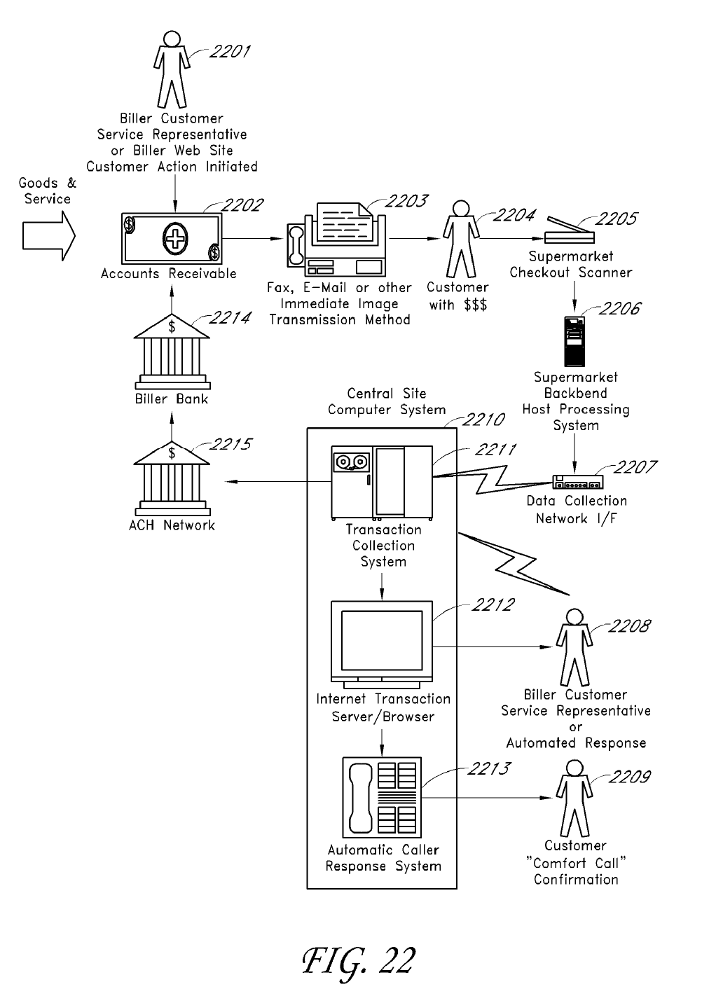

Turning now to FIG. 22, an exemplary improved electronic bill payment network 2200 is illustrated. For all the goods and services rendered to a consumer over a given traditional billing period (or interactive Internet shopping session), the biller accounts receivable 2202 may accumulate a dollar total and generate a detailed bar coded invoice statement image 2203 that can be electronically remitted to the consumer 2204, i.e. an invoice surrogate. This same process can also be used by a biller customer service representative 2201 to replicate a previous invoice statement that a consumer may have lost. For example, if a consumer wants an immediate replacement copy of the invoice for payment, the consumer can access a biller web site to generate a remittance or deposit document. The time for a consumer to request the electronic invoice statement 2203 may be as little as a few minutes after a request is made. The invoice 2203 is transmitted to the consumer 2204, a process that may take from a few seconds to several minutes, depending on factors such as the method of transmission, queue capacity, and number of open queue slots. The consumer 2204 receives the bar coded invoice statement image 2203.

To pay the bill with one of these invoice surrogates, the consumer 2203 might go to a local store (or other location with appropriate hardware/software/network connection) that processes these bill payments. The time for this to occur is variable, depending upon the consumer's circumstances, and may occur in as little as a few minutes. The consumer 2203 presents his imaged bar coded invoice statement 2203 to the checkout cashier for scanning by the checkout scanner 2205, which may be done while other retail UPC coded items are being scanned. As with the other embodiments described herein, instead of looking up an in-house UPC code for pricing, the scanner 2205 would pick up the bill payment bar code, identifying the biller to be paid and the account number to be credited. The consumer tells the checkout cashier the amount to be paid on that account, and chooses an of either “normal” or “express” payment processing. (Both processing options incorporate the appropriate payment time-stamp, i.e. the customer always “gets credit” for making the payment at the time it is actually made. However, “express” payments are expedited with respect to notifying the biller—which may impact external biller actions, such as service shut-off or credit denial.) The cashier then inputs the amount to be paid into a terminal (which may be integrated into a point-of-sale system), which is in communication with a backend host processing system 2206. The checkout of remaining products and items (or bills) continues until the complete total for all goods and services is calculated. Upon receiving payment from the consumer, that bill payment is then complete. The consumer may receive a printed receipt of the payment tendered, showing the date and time the payment was made. The in-store backend host processing system 2206 immediately completes and forwards all the payment data to the data collection network interface (DCNI, described above) 2207, which may occur in a little as a few seconds.

In this embodiment, the DCNI performs the basic operations described in the earlier discussion of FIG. 5, viz. transmitting batches of data to the central site transaction collection system 2211, which is part of a central site computer system 2210 that may also include an Internet server/browser 2212 and/or automatic caller response system 2213. However, when a particular consumer payment is designated for “express” processing, the payment would be flagged, and transmitted to the central site computer system 2210 as soon as the transaction void window expires for that payment.

The transaction collection system 2211 performs the basic operations described in the earlier discussion of FIG. 5, viz. receiving payment data from DCNIs 2207, and the various processing steps needed to submit payments through the Federal Reserve Automated Clearing House (ACH) Network 2214.

As the transaction collection system 2211 receives payment data from DCNIs 2207, it processes and stores each consumer bill payment into a database. Once stored in the database, that payment and ancillary information can be viewed with a local transaction browser or Internet web site display 2212. When “express” payments are encountered in the payment data stream, immediate electronic notification may be posted to the biller, in one of several possible forms, e.g. e-mail, facsimile, or a biller-specified custom electronic form. Accessible from that same database information, an automated caller response system 2213 can verbally confirm the receipt of a particular transaction, particularly for customers 2209 seeking “comfort call” confirmation regarding the status of a payment. For “normal” payments, the biller customer service toll-free number may be nominally printed on the consumer receipt. For “express” payments, the normal biller customer service toll-free number may be replaced with a special priority toll-free number and payment-specific access code, to relieve biller customer service representatives 2208 of nervous consumer confirmation inquiry calls, typically for payments that are long overdue. Automated text-to-speech (TTS) services via interactive voice response (IVR) could expedite such services, while managing costs.

Other aspects of this system are substantially as described for FIG. 5, viz. processing and distribution of electronic payment data via the Federal Reserve Automated Clearing House (ACH) Network 2214, receipt and processing of payments at the biller's bank 2215, and processing of payments by the biller's accounts receivable 2202 and/or customer service computer files.

From both the biller's and consumer's perspective, the payment network/system 2200 described in this section may be contrasted with the biller-payor network/system 500 (described above with reference to FIG. 5 et seq.), as follows:

From the biller perspective, both networks 500 and 2200 may be capable of delivering good payment funds and data directly into the biller's bank account by 6 AM the next business day after the consumer pays a bill at retail. All payment funds collected can remain safe and secure within the Federal Reserve banking system network at all times. The enhanced network 2200 may deliver the following additional benefits: a) Electronic notification of consumer payment information to the biller within minutes after the payment is made at retail, through use of the “express” delivery service. b); Immediate electronic delivery of a consumer invoice, assuming that the biller can generate and transmit an electronic invoice statement image 2203 and that the consumer has a corresponding device or means with which to receive the electronic biller invoice statement image (e-mail, facsimile, etc.; note also that a retailer could provide such access as a customer service); c) Automatic confirmation of a consumer's payment, by using an Internet browser to query the database of processed transactions in the transaction collection system 2211, subject to a variety of database selection keys and criteria; d) Receipt of full payment funds for the amount stated on the bar coded invoice statement 2203 (or such other amount paid by the customer). This point is especially important when it comes to paying various governmental and state license, permit, and tax fees. By statute, many states and governmental organizations cannot accept the payment of license, permit, and tax fees from consumers using either credit or debit cards, because of the subsequent discounted payments remitted. Third-party payment surcharges, directly assessed from the consumer over and above the due payment amount, are generally acceptable. (For example, the Commonwealth of Massachusetts has 307 different types of license, permit, and tax fees that must be paid by consumers either by check or cash.)

From the consumer perspective, the enhanced network 2200 may deliver the following additional benefits: a) Immediate electronic delivery of an invoice (subject to the assumptions listed above); b) Having a choice of local payment method (e.g., cash, check, debit card, or any credit card), when paying an electronically-delivered bar coded invoice statement 2203 at retail; c) Avoiding the need to divulge any personal financial information to make such a payment, not an option with today's remote Internet storefronts; d) Subsequent confirmation of electronic receipt of payment via an automatic caller response system 2213, offering a finer detail status granularity than is now possible from existing caller response systems (which offer only a binary status, i.e. received/not received); e) Subsequent confirmation of payment via an Internet browser, used to query the database of processed transactions in the transaction collection system 2211 with a specific transaction identification number.

Presently, for Internet commerce based companies, there is no mechanism available for conducting a purely “cash” sale over the Internet, where consumer cash and retail product can be exchanged in one anonymous atomic transaction. Currently, problems abound with all other payment methods, as described below.

Payment method fees always erode the profit margin of any retail or Internet storefront. Credit and debit card companies charge retail merchants varying commissions, based on a variety of factors that can range upwards from 2% of the purchase price. By law, these merchants cannot charge consumers different prices for the same retail product, whether paid for with cash or by credit. Check guarantee companies impose processing charges on every consumer check passed through their service. Third party “e-wallet” payment companies also charge for their value-added services. Therefore, the merchant must absorb these various discounts from profit margins, as a normal “cost of doing business”. Checks, if exchanged, take time to clear, and can be “stop paid” at the whim of the consumer. Financial exposure can be avoided on check payments by the seller choosing to wait out the prescribed check clearing time (on average, approximately 4-5 days, although in some circumstances an item may be rejected up to 10 days after presentation). However, ultimate consumer satisfaction will be impacted by this delay. Credit card transactions require the consumer to divulge personal financial information to the remote Internet seller, which leaves open the potential for future and untraceable fraud; a similar risk exists when using a third-party computer system, or one infected by a virus or spyware. Once placed, that credit card transaction can still be disputed and repudiated by the consumer, up to 60 days later, leaving the seller with an uncollectable debt. While debit card transactions cannot be repudiated, they also require the consumer to divulge personal financial information to the remote Internet seller, which again creates a potential for fraud. The consumer generally has no guaranteed recourse to recover any stolen funds debited from a bank account. Third party “e-wallet” payment companies generally require consumers to register their bank account numbers for secured transaction payments over the Internet, making them ripe for large-scale fraud. The consumer generally has no guaranteed recourse to recover any stolen funds debited from his E-Wallet.

The enhanced electronic bill payment network 2200 consistent with the present disclosure permits remote buyers and sellers to perform anonymous “cash” sale transactions, using the Federal Reserve banking system as the trusted escrow agent, thereby safely and securely transferring funds between buyers and sellers.

An advantageous feature of this enhanced bill payment network, with a standardized bar coded bill payment “signature” featured as its centerpiece remittance mechanism, is that all the non-deterministic/non-volitional time delays have been removed from the total bill payment cycle. In legacy bill pay arrangements, the two largest delay factors are: a) the biller's process of invoice paper statement preparation, printing, mailing systems, etc.; and b) the US Post Office mail delivery system. With the present disclosure, the consumer can now exercise a larger amount of control over the bill payment remittance process. The consumer can request an immediate invoice statement, which only requires minutes to formulate and to deliver electronically. The consumer has a choice of payment methods at a trusted local retail establishment, and receives a printed bill payment receipt confirmation, guaranteed by the biller. The consumer payment method to the biller is completely anonymous, in terms of divulged personal financial information. Subsequently, the consumer, as well as the biller, can verify that the bill payment has been received and processed at the central payment distribution site. Thereafter, payment funds and information may be electronically remitted to the biller within hours, with funds received by 6 AM the following business day directly into the biller's bank account.

It should be recognized by those skilled in the art that, although the foregoing description refers to a bar code transmitted by e-mail or by facsimile for use as a surrogate invoice, other methods of transmission are possible, and are included as possible embodiments of the disclosure, e.g., facsimile transmission to or from a computer, facsimile machine, e-mail, file transfer protocol (FTP), hypertext markup language (HTML), extended markup language (XML), hypertext transport protocol (HTTP), modem, the Internet, wireless communication mechanisms such as BlueTooth, a wide-area network (WAN), a local-area network (LAN), diskette, memory card, USB Flash Drive, or any other removable storage medium. Similarly, a bar code “signature” for use as a surrogate invoice can be created through the use of a range of mediating technologies, e.g. translation between barcode symbologies, translation of text from a paper or electronic invoice, or database lookup to convert a transaction serial number to an account number.

### Money Transfer Embodiments

In the above descriptions of an exemplary electronic bill payment network 500 (described above with reference to FIG. 5 et seq.), references have been made regarding the extensibility of this network and its internal structure to provide for new, cost-effective financial products and services. Another such embodiment is the implementation of domestic and international person-to-person money transfer services. (Of course, the money transfer technology described by example in this section may also have applicability to business-to-person, person-to-business, business-to-business, or other types of money transfers.)

The domestic and international money transfer services offered today are very labor-intensive, for both the person sending the money as well as the service provider. The amount of paperwork that has to be filled out by the sender, and then manually transcribed into a “communication system” by the service provider, has been the ostensible justification to the customer of the high fee structure demanded by providers of this service. In point of fact, this service is extremely profitable, a fact that is amply demonstrated by the fact that there are so many large and small money transfer service providers in this industry, primarily serving immigrant communities, whose members regularly send money to their home country families. Some service providers, such as Western Union, use relatively “high tech” electronic communication services to transfer funds; while other, small service providers use “low tech” courier services to physically transport funds to their intended destination.

Currently, several organizations sell domestic or international electronic person-to-person money transfers, requiring that the sending and receiving parties deposit and pick up the remitted funds within the same organizational network of geographically dispersed branch offices. Fees for this service can range upwards from $35 per transfer. However, convenient remittance locations for the local sender may not have corresponding convenient delivery locations for the remote receiver, or vice-versa.

In a system consistent with the present disclosure (Example System X), domestic person-to-person money transfers can be easily accomplished with a bar coded deposit slip that permits a remote sender to remit funds directly into a receiver's bank checking account. This system allows the receiver to access funds at a convenient local automated teller machine (ATM), or use them for a debit card purchase.

Using this system, future international (e.g., Mexican) person-to-person money transfers could be coordinated with appropriate financial organizations or banks that commonly distribute a form of debit card to their customer base. These organizations would distribute plastic bar coded deposit-only cards to their customer base, keyed directly to these debit cards, and which could then be sent to remitters in another country (e.g., the United States). Using such a bar coded plastic deposit-only card, instead of a bar coded bank deposit slip, would effect a deposit of funds directly into the debit card account that corresponds to the deposit-only card. In this way, very simple domestic and international money transfers could cost far less than the fees charged today for this equivalent service.

The complete details of a bar coded bill payment “signature” are described above in the section entitled “Bar Coding Validation” with respect to FIGS. 10 and 11, wherein a structure of successive data envelopes of embedded “signature” data fields are employed, consisting of a series of format designators, data and check digits. In the examples of FIGS. 10 and 11, which illustrate two arbitrary format designator values, the customer account number consisted of one numeric field, whose associated check digit was the trailing digit of either a divulged format (=3) to which the biller appended a check digit according to a specified algorithm, or an unknown format (=4) to which such a check digit was appended as part of the payment processing method. In both cases, there is an independent mechanism in place to mathematically check the validity of the customer account number.

In the person-to-person electronic money transfer embodiment described in this section, the same retail-based electronic bill payment infrastructure is utilized, with certain modifications as described below. Two scenarios must be considered: 1) Where the intended recipient can receive funds via a transaction submitted directly to the Federal Reserve Automated Clearing House (ACH) network, naming the recipient's account as the funds destination. 2) Where the intended recipient cannot be sent a transaction in this way, but where, instead, funds must be routed through a third-party payment network. The latter case would apply with any international transfer, for example, since the recipient lies beyond the reach of the ACH. (Specific banking rules, determining whether such a payment would be permissible to a particular individual's U.S. domestic bank account, are irrelevant to this discussion. Both cases must be supported, and are described below.)

Both cases are addressed by a simple modification to the bar code format. A small number of special biller identifiers are reserved, and used to identify the available person-to-person payment networks. Foremost among these would be the Federal Reserve Automated Clearing House (ACH), a network for performing transfers to domestic U.S. bank accounts. Additional entries in this short list would identify international payment destinations, such as overseas banks and overseas money transfer services. (In addition, the list could include payment transfer mechanisms for the use of the unbanked, who cannot take advantage of the ACH.) A special bar code suitable for making a person-to-person transfer would thus comprise at least two data elements: 1) the desired person-to-person payment network; and 2) the recipient's account number within that network. This is essentially the same information in a normal bill payment bar code, but the biller identifier has been replaced with a network identifier.

To see how this works, first consider the case of a person-to-person transfer in which the transaction can be sent directly via ACH. The first field, the network identifier, is a reserved code identifying the ACH. But what goes in the account number field? In the U.S. banking system, the standard bank account numbering scheme is based on a two-part number system consisting of: a) an ABA (American Banking Association) number (8 digits plus a check digit), uniquely identifying the U.S. bank institution; and b) a local bank account, using a numbering convention adopted within that banking institution. Both parts of this number must be placed in the bar code's account number field.

Before showing how this would be represented, consider the other case, where the ACH will not be used. In this case, a different network identifier would be placed in the first field, e.g. an identifier for a Mexican bank, a domestic payment transfer network, or a European banking network. An associated account number within that network would be placed in the second field. When the network is comparable to the ACH, and provides access to many different institutions, each with independent account structures, then the second field's value will consist of two or more elements (as with the account number in an ACH transfer). Otherwise, i.e. when a network's payment recipients are identified with a single account number, the second field's value will consist of a single element. Each network will of course have its own account number format.

To store the network identier and account number within a bar code, the unknown format (=4) designator validation template scheme could reliably be used. This would provide a generalized person-to-bank-account and person-to-service-account remittance mechanism, within the structure of the exemplary electronic bill payments infrastructure already described earlier. However, since the majority of such transfers will specify an ABA bank account destination, the preferred approach is to define a new format (e.g. =5) designator validation template for flagging U.S. domestic person-to-person transfers, optimized for ACH transfers. This code indicates that the first field is a network identifier, and that the second field is a standard ABA account destination. This approach would offer several advantages: a) An additional customer account number validation step further reduces data errors. b) Within the full customer-specified account number, the ABA portion of the account number can be independently verified. c) The normal bar code format's biller identification number could be reduced from 6 to (say) 2 digits, in recognition of the fact that there are many fewer bank-based or money transfer payment networks than conventional billers. d) This reduced first bar code string will help fit printed bar codes on small banking deposit slips (that measure, on average, 6″ wide by 3″ high).

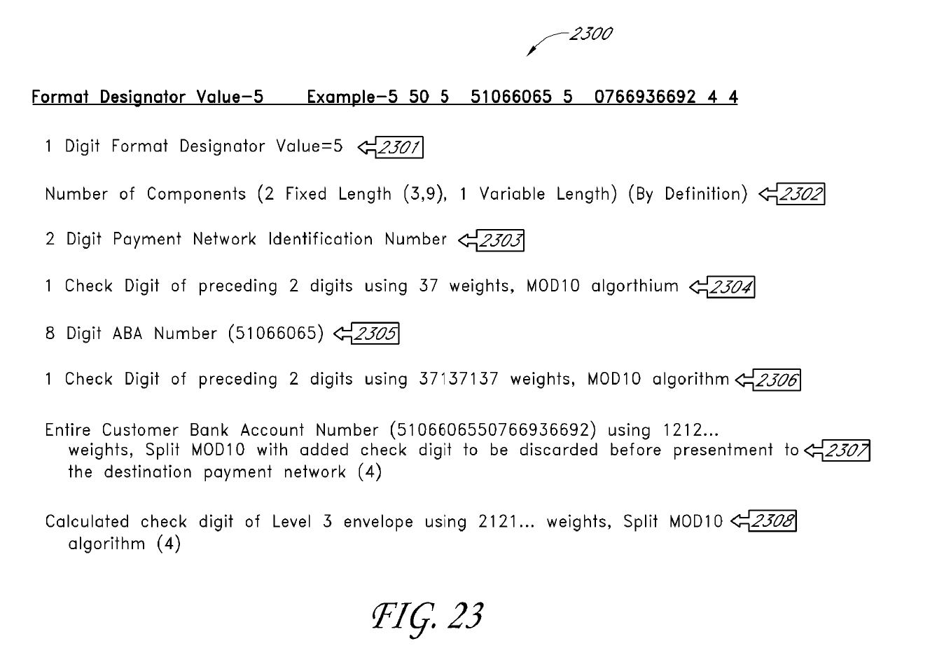

FIG. 23 illustrates an exemplary specification for such a new format (=5) designator. For simplicity, it only considers the case of an ACH payment destination. As shown, the bar code 2300 comprises a 1-digit format designator (=5); the number of components (2 fixed length (3, 9), 1 variable length) by definition; a 2-digit payment network identification number; 1 check digit for the preceding 2 digits, using 37 weights, MOD10 algorithm; an 8-digit ABA number (51066065); 1 check digit for the preceding 8 digits, using 37137137 weights, MOD10 algorithm; the entire customer bank account number (5106606550766936692) using 1212 . . . weights, split MOD10, with an added check digit to be discarded before presentment to the destination payment network; and a calculated check digit for the level 3 envelope, using 2121 . . . weights, split MOD 10 algorithm.

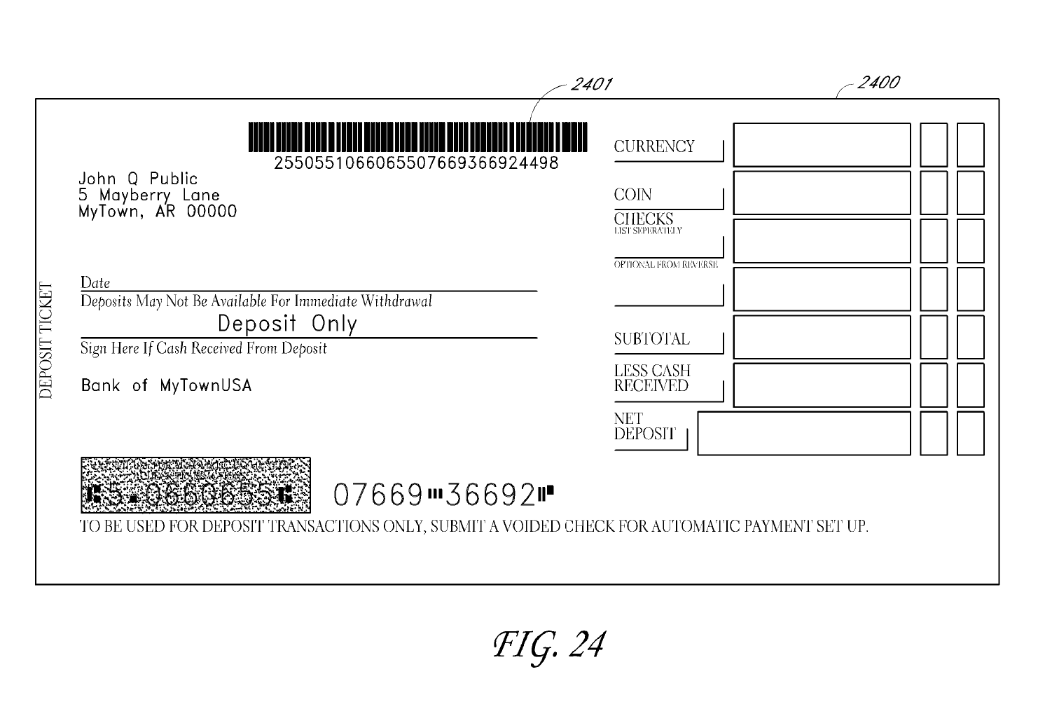

As illustrated in FIG. 24, this bar code 2401 appearing on a bank deposit slip 2400 could be presented at a retail checkout aisle equipped for bill payment transactions, to initiate domestic person-to-person money transfers. (Alternatively, and for the same purpose, the bar code 2401 could be printed on a plastic or paper card, or printed on other media, e.g., debit card, credit card, bank card, affinity card, card bearing a magnetic stripe, identification card, smart card, or card bearing at least one name corresponding to an account number encoded in said bar code.) By 6 AM the following business day, the money remitted the previous day may be available to the recipient to withdraw from a local ATM machine, or to make a payment from a debit card keyed to or associated with that account. Note that the ATM or debit card PIN (personal identification number) provides the same level of access security to the receiver of these person-to-person money transfers as exists for local funds that already reside in the account.

As indicated above, this same approach is easily applied transfers using international networks (i.e., implementing the capability for any-person-to-any-person electronic money transfer). Again, the first bar code field may be used to uniquely identify the target destination payment network, from a “short list” of payment networks. In the case of a foreign payment network, based on a system of debit card accounts, the unknown format (=4) designator validation template scheme can reliably be used to implement and validate any generalized account numbering scheme to remit funds. Alternatively, creating a new format (e.g. =6) designator validation template definition would offer extended customer account number verification advantages. This would only be practical if the destination payment network is willing to divulge its mathematical or other method of customer account numbering validation scheme.

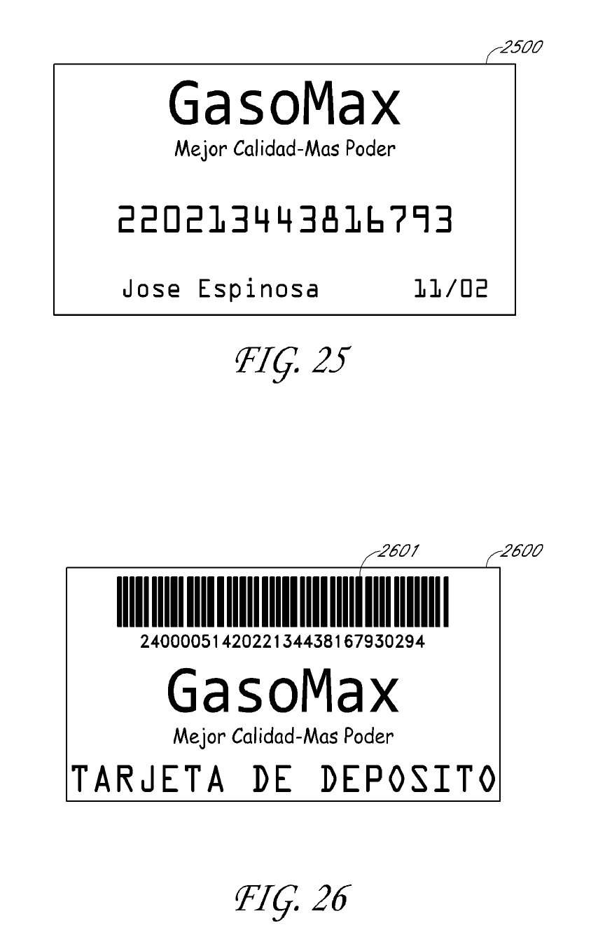

In a related hypothetical exemplary scenario consistent with the disclosure (illustrated in FIGS. 25 and 26), a national chain of retail gas stations/convenience supermarket stores called GasoMax is located throughout the whole of Mexico, serving the public at large. GasoMax issues PIN protected debit cards to all their customers—in effect, setting up a pseudo-bank account for each of them. Instead of carrying cash, these customers deposit or apply money to these accounts, so that they can later purchase food staples or convenience items at the same time they come for fuel. When GasoMax issues these PIN-protected debit cards to their customer base, one or more deposit-only cards (containing bar code consistent with this disclosure) are included; alternatively, such a bar code might be printed on the debit card itself. The bar coded instruments can be used to deposit funds through the mechanisms described in this disclosure. The debit card can also be used to withdraw money, in the form of purchases at the national chain GasoMax gas stations. Additional detail follows below.

FIG. 25 illustrates an exemplary GasoMax debit card 2500, which resembles a standard debit card. FIG. 26 illustrates an exemplary deposit-only card 2600 comprising a bar code 2601 consistent with the disclosure. In this exemplary scenario, the bar coded deposit-only card 2600 (or, alternatively, such a bar code printed on the standard debit card) would be used in U.S. retail stores that offer access to the electronic bill payment network. Unlike most customers, who submit their U.S.-based biller bar coded invoice statements to the cashier for payment, the customer presenting a GasoMax bar coded deposit-only card 2600 is making a payment via a destination payment network (Payment Network=51, using a standard unknown format (=4) designator. Payments remitted to this payment network are automatically converted to local currency by GasoMax, at a better rate than the larger commercial money transfer organizations. (Commercial money transfer companies charge up to $25 per $300 remittance as a foreign exchange (FX) fee on top of the base $35 remittance fee. In the recent past, wire transfer companies have been sanctioned for these usurious currency exchange practices.) GasoMax would have a greater incentive to offer a better exchange rate to its customer base for its money transfer services than the current crop of commercial money transfer services. GasoMax would gain a “captive market”, as deposited funds would primarily or exclusively be used to purchase goods and services through its chain of gas station supermarkets. (This is the same “company store” advantage obtained with gift certificates.) GasoMax would also be able to expand its local customer base, by offering a convenient money transfer service as an affinity draw or loyalty program, appealing to those with relatives working outside of the country to support loved ones in Mexico.

The following examples provide “real-life” scenarios that demonstrate the utility of an improved payment network consistent with the disclosure:

Payment for Mobile Telephone Service (Example Scenario Y)

A client procures a mobile phone subscription from a well-known national vendor. The client uses his place of employment as his cell phone billing address. As a new customer, he is assigned a total credit limit and an accrued monthly limit. This client subsequently leaves his place of employment, but forgets about changing his mobile phone billing address, and continues to use his mobile phone regularly—until one day, his mobile phone stops working. When he calls the customer service office to inquire about the matter, he finds out that his mobile phone usage is well within his credit limits, but that his mobile phone was disconnected because the current bill payment is overdue by ten days. The phone company does not accept credit card payments, and will only accept a check payment for the total past due amount. The client submits a check payment, and the company then restores his service—ten days after receiving and processing that check.

With an enhanced bill payment network consistent with the disclosure in place, this client could have remitted the late payment with the “express” payment service, as described above. The mobile phone company would have been electronically notified minutes after his retail payment, so that cell phone service could be restored within an hour, rather than days.

Payment for Internet-based Auction (Example Scenario Z)

The business model for the Internet-based auction (e.g., eBay) is very basic in concept, a meeting place for bringing together Internet buyers and sellers, wherein an electronic framework displays sellers' goods and services, and accepts buyers' bids and other payment offers. When a sale is completed between a seller and a buyer, the online auction house charges a sales commission. It is the responsibility of the seller and the buyer to establish an agreed payment exchange method. Individuals selling items, are generally not equipped to process MasterCard or VISA credit or debit cards. If the seller accepts a personal check payment from the buyer, shipment of the sold item is delayed until the buyer check clears. A buyer can somewhat mitigate this seller shipment delay by purchasing and sending a money order to the seller. A majority of sellers are willing to use a third-party payment clearinghouse, (e.g., Billpoint or PayPal), which provides additional payment options; but both buyer and seller must register personal bank account and/or credit card information to transfer money. Such services also involve yet another sales commission charge. In general, none of these payment alternatives are particularly attractive if a buyer or seller desires financial confidentiality.

With an electronic payment network consistent with the disclosure in place, an online auction house could provide a cost-effective, value-added, anonymous payment alternative within its framework of auction services. When a sale is completed, the online auction house provides the means for the buyer to print out a bar coded invoice statement, citing the online auction house as the biller of record, with a transaction identification number. Instead of purchasing a money order, which would then have to be physically remitted, the buyer simply pays this invoice at a local supermarket. When the online auction house receives the electronic payment the next business day, it notifies the seller of the completed payment via e-mail, and sends a check for that payment amount to the seller (or credits the seller's bank account). Aside from disclosing their mailing addresses, both buyer and seller maintain their financial privacy. Alternatively, this service could be added to the offerings of a third-party payment clearinghouse such as PayPal, allowing the auction house to avoid any fiduciary role (and its associated liability) in the transaction.

This same sales paradigm would also work well for home shopping television channel environments, (e.g., Home Shopping Network, QVC), wherein the “express” payment option could be used when buyer desire is at its highest level.

Insurance Payment (Example Scenario AA)

Insurance companies have varying grace periods within which clients must pay their insurance premiums, beyond which the policy is irrevocably canceled. If one cannot or chooses not to pay the entire annual premium on its anniversary date, an installment plan of smaller payments may alternatively be offered. If a premium payment is not received, a cancellation notice is sent toward the end of the payment grace period, specifying a “hard” cancellation date. If a policy is canceled due to non-payment, then depending on the prior payment history, the insurance carrier may decline to reissue another insurance policy. Given the gravity of the possible consequences, time is of the essence when it comes to paying insurance premiums on time—whether for car insurance, home insurance, or personal life insurance. Mailed late payments may not be delivered and processed in time. Depending on company policy, even in-person payments directly to insurance agents, during normal business hours, may or may not be acceptable. A confirmed electronic payment, made using an enhanced bill payment network consistent with the disclosure, would provide a way for both the insurance company and insureds to know precisely when premiums are paid.

Payment to College Student (Example Scenario AB)

When a parent agrees to send money for college expenses to a child away at school, a question that typically arises is “How fast do you need the money?” A printed bar coded bill payment “signature”, preprinted on out-of-town bank checking account deposit slips, would enable remote deposits with a simple cash, check, debit card, or any credit card payment at a local supermarket. A prudent college-bound child could send home an ample supply of these deposit slips to cover such eventualities. If a supply of originals is not available, a facsimile copy (sent at high resolution mode) could serve in the role of invoice surrogate. Funds deposited with this payment mechanism are electronically available the next morning, for withdrawal from a local ATM cash-dispensing machine. For a small fee (e.g., $1.50), this service is much faster, more convenient to all parties involved, and more cost-effective than any existing person-to-person money transfer service.

### Alternative Embodiments

Although certain embodiments of the present disclosure have been described as utilizing a Code 128 bar code, the code used need not be limited as such. Those skilled in the art will appreciate that the principles involved in the present disclosure apply equally to other types of codes, including both non-128 bar codes and 2-D glyphs. Other bar codes that can be used might be linear or non-linear. Examples of linear bar codes include Code 39, Code 93, and EAN 13. Examples of non-linear barcodes include stacked barcodes (such as Code 16K) and 2D or matrix bar codes (such as DataMatrix). The common characteristic of all of these codes is that they are all machine-readable (i.e., computer-readable), and thus can be used in implementing the bill payment systems described herein.

The present disclosure may use the public Internet and Internet-compatible protocols such as HTTP, TCP, and UDP, for the network interconnections described herein, as well as the Federal Reserve Automated Clearing House (ACH) Network or other networks. Those skilled in the art will recognize that the servers and their various components, as well as any other technical components described herein, may be implemented in software, hardware, or a combination of both, and may be separate components or be integrated into other components as described above. Likewise, the processes described herein may be separate or combined, and may run on common, shared, or separate machines, and may be implemented as integrated or separate software modules.

Additionally, the scanning of bar codes, in methods consistent with the disclosure, may be performed using, e.g., wand or handheld scanning devices, scanning devices mounted to or near a point of sale system, and other such scanning devices. Moreover, such devices coupled to other devices, e.g., a computer, cash register, kiosk, or point of sale system, or alternatively, integrated therein. A scanning device consistent with the disclosure may thus alternatively be coupled to or integrated into a PDA, handheld or pocket computer, as well as a mobile telephone or other portable, wireless, or computerized device. Thus, it is contemplated that an account corresponding to a mobile telephone or other such device, or other credit or debit account corresponding to the user of such a device, could be automatically debited for payment to a payee, in methods consistent with the disclosure.

It will be appreciated by those skilled in the art that the functional components of the above described embodiments of the system of the present disclosure are each presented in terms of specific illustrative elements, such as distributed computer program processes, data structures, databases, dictionaries, other stored data, conventional general purpose computers (e.g. IBM-compatible, Apple Macintosh, and/or RISC microprocessor-based computers), mainframes, minicomputers, conventional telecommunications methdods (e.g. modem, DSL, T-1, satellite, and/or ISDN communications), memory storage means (e.g. RAM, ROM), storage devices (e.g. computer-readable memory, disk array, direct access storage), conventional network hardware and software (e.g. LAN/WAN network backbone systems and/or Internet). This specificity notwithstanding, other types of technology, including other computers, data storage strategies, or communications methods may be used instead, without departing from the present disclosure.

In particular, the disclosure as described herein may be embodied in one or more computers, residing on one or more server systems, having input/output access enabled via the use of appropriate hardware and software (e.g. personal and/or mainframe computers provisioned with Internet wide area network communications hardware and software (e.g. CGI-based, FTP, Netscape Navigator™ or Microsoft Internet Explorer™ HTML Internet browser software, and/or direct real-time TCP/IP interfaces accessing real-time TCP/IP sockets). Such mechanisms would be chosen to permit human users to send and receive data, or to allow unattended execution of various operations, in real-time and/or batch-type transactions and/or at user-selectable intervals. Likewise, servers consistent with the present disclosure may be remote Internet-based servers accessible through conventional communications channels (e.g. conventional telecommunications, broadband communications, or wireless communications) using conventional browser software (e.g. Netscape Navigator™ or Microsoft Internet Explorer™), in which case the exemplary embodiments describe herein would be appropriately adapted to include such functionality. Additionally, those skilled in the art will recognize that the various components of the systems described in the present disclosure can be remote from one another, and may further comprise appropriate communications hardware/software and/or LAN/WAN hardware and/or software to accomplish the functionality herein described. Alternatively, a system consistent with the present disclosure may operate completely within a single machine, e.g. a mainframe computer, and not as part of a network.

Moreover, each of the functional components described in the exemplary embodiments of the present disclosure may be implemented as one or more distributed computer program processes, running on one or more conventional general purpose computers, networked together by conventional networking hardware and software. Alternatively, each of these functional components may be implemented by running distributed computer program processes (e.g., generated using “full-scale” relational database engines such as IBM™, Microsoft SQL Server™, Sybase SQL Server™, or Oracle 11.0™ database managers, and/or a ODBC interface to link to such databases) on networked computer systems (e.g. comprising mainframe and/or symmetrically or massively parallel computing systems such as the IBM z/Series™ or HP 9000™ computer systems), including appropriate mass storage, networking, and other hardware and software as appropriate for these functional components to embody the stated functions. Moreover, such computer systems may be located at a single facility or geographically distributed and connected together via appropriate wide- and local-area network hardware and software.

Primary elements of the disclosure may be server-based and may reside on hardware supporting an operating system such as Microsoft Windows NT/XP/200x™ or UNIX/Linux. Clients may include computers with windowed or non-windowed operating systems, e.g., a PC that supports Apple Macintosh™, Microsoft Windows 95/98/NT/ME/XP/200x™, or MS-DOS™, a UNIX Motif workstation platform, a Linux Gnome or KDE platform, a non-windowed UNIX/Linux platform, a Palm™, Windows CET™-based or other handheld computer, a network- or web-enabled mobile telephone or similar device, or any other computer capable of TCP/IP or other network-based based interaction. The communications media described herein (generally referred to using the generic term “network”) may be a wired or wireless network, or a combination thereof.

Alternatively, the aforesaid functional components may be embodied by a plurality of separate computer processes (e.g. generated via dBase™, Xbase™, MS Access™ or other database management systems or products) running on IBM-type, Intel Pentium™ or RISC microprocessor-based personal computers, networked together via appropriate networking hardware and software, and including such other additional appropriate hardware and software as is necessary to permit these functional components to achieve the stated functionalities. In this alternative configuration, since such personal computers may be unable to run full-scale relational database engines of the types presented above, a non-relational flat file “table” may be included in at least one of the networked personal computers to represent at least portions of data stored by a system consistent with the present disclosure. These personal computers may run, e.g., UNIX/Linux, Microsoft Windows NT/200x/XP™ or Windows 95/98/ME™ operating systems. The aforesaid functional components of a system consistent with the present disclosure may also comprise a combination of the above two illustrative configurations (e.g. by computer program processes running on a combination of personal computers, RISC systems, mainframes, symmetric or parallel computer systems, and/or other appropriate hardware and software, networked together via appropriate wide- and local-area network hardware and software).

As those skilled in the art will recognize, possible embodiments of the disclosure may include one- or two-way data encryption and/or digital certification and/or n-factor authentication for data being input and output, to provide security to data during transfer. Further embodiments may comprise security means by including one or more of the following: password or PIN number protection, use of a semiconductor, magnetic or other physical key device, biometric methods (including fingerprint, nailbed, palm, iris, or retina scanning, handwriting analysis, handprint recognition, voice recognition, or facial imaging), or other security measures known in the art. Such security measures may be implemented in one or more processes of the disclosure.

Source code may be written in an object-oriented or non-object-oriented or other programming language, using relational, flat-file, or other databases, and may include the use of arbitrary programming languages, e.g., C, C++, C#, Java, JavaScript, HTML, Perl, PHP, Python, Ruby, UNIX shell scripting, assembly language, Fortran, Pascal, Visual Basic, or QuickBasic. It is further noted that the screen displays illustrated herein at FIGS. 15-21 are provided by way of example only, and are not to be construed as limiting the disclosure or any component thereof to the exemplary embodiments illustrated therein.

It is also contemplated that the system and method described herein may be implemented as part of a business method, wherein payment is received from users, which might include customers, retailers, and/or billers employing the inventions described in the present disclosure. The user-level features described in the above embodiments may or may not be made visible to such users, who may simply perceive an overarching business relationship that is predicated on the existence of such services. Such users may pay for their conscious or unconscious use of the services enabled by the disclosure, based on such measures as: a) the number of files, messages, bills, or other units of data sent or received or processed; b) bandwidth used, on a periodic (weekly, monthly, yearly) or per-use basis; or c) in a number of other ways consistent with the disclosure, as will be appreciated by those skilled in the art.

Furthermore, although embodiments of the present disclosure have been described in the context of bill payment transactions and money transfers, those skilled in the art will recognize that the illustrative systems described can apply equally to other forms of monetary transactions. For example, the systems and methods described herein can likewise consummate transactions involving gift cards, credit cards, debit cards, smart cards, and other forms of electronic monetary transactions, including bank account transactions such as deposits and the replenishment of Internet wallets.

Those skilled in the art will recognize that the present disclosure may be implemented in hardware, software, or a combination of hardware and software. Finally, it should also be appreciated from the outset that one or more of the functional components may alternatively be constructed out of custom, dedicated electronic hardware and/or software, without departing from the present disclosure. Thus, the present disclosure is intended to cover all such alternatives, modifications, and equivalents, as may be included within the spirit and broad scope of the disclosure as defined only by the hereinafter appended claims.

What is claimed is:

1. A digital bar code for use in an electronic monetary transaction, the bar code comprising a digital array set of electronically readable data, the set array including information about at least one party to the monetary transaction, the bar code further comprising an algorithmic signature identifying said bar code as corresponding to a particular type of monetary transaction and thereby permitting an electronic communication from an electronic scan of said bar code to be used to both direct a transfer of funds and to alert the at least one party to said transaction that the transaction has been made, wherein the bar code may be presented by a user in electronic digital form to a third party for purposes of carrying out the transaction.

2. The digital bar code of claim 1, wherein the monetary transaction is a bill payment transaction

3. The digital bar code of claim 1, wherein the monetary transaction is a remittance transaction.

4. The digital bar code of claim 1, wherein the bar code is visually displayed on a portable card.

5. The digital bar code of claim 1, wherein the bar code is visually displayable on a portable electronic device.

6. The digital bar code of claim 5, wherein the portable electronic device comprises a cell phone.

7. The digital bar code of claim 5, wherein the portable electronic device comprises a music player.

8. The digital bar code of claim 1, wherein the bar code is created by a mediating technology that translates third party data into the bar code.

9. The digital bar code of claim 8, wherein said mediating technology translates the third party data into the bar code through electronic processing that may include the translation of barcode symbologies.
